(19) United States
(12) Patent Application Publication
(10) Pub. No.: US 2026/0053113 A1
(43) Pub. Date: Feb. 26, 2026

(54) PET TOY

(71) Applicant: Towerstar Pets, LLC, Malvern, PA (US)

(72) Inventors: Fernando Becattini, JR., Malvern, PA (US); Jacquelyn N. Becattini, Malvern, PA (US); Fernando Becattini, SR., Devon, PA (US); Steve A. Copeland, Barrie (CA); Nicholas Teixeira, Angus (CA)

(73) Assignee: Towerstar Pets, LLC, Malvern, PA (US)

(21) Appl. No.: 19/374,626

(22) Filed: Oct. 30, 2025

Related U.S. Application Data
(63) Continuation-in-part of application No. 18/611,083, filed on Mar. 20, 2024.

(51) Int. Cl. A01K 15/02; A01K 5/01

(52) U.S. Cl. CPC A01K 15/026; A01K 5/0114

(57) ABSTRACT

A pet toy has a unique configuration that is able to dispense a pet treat from the body thereof. The body has holes that extend axially through the body and are in communication with a center cavity. When a pet treat is disposed within the cavity, a syringe-style plunger can be used to expel the pet treat through the holes out of the cavity. Further, the pet toy can also have two enlarged end members that have different diameters that cause the pet toy to move in a curved trajectory as the pet toy rotates about its longitudinal axis.

### CROSS REFERENCE TO RELATED APPLICATIONS

This application is a continuation-in-part of U.S. patent application Ser. No. 18/611,083, filed on Mar. 20, 2024, the entirety of which is incorporated herein by reference.

### TECHNICAL FIELD

This disclosure is directed to a pet toy.

### BACKGROUND ART

Pet toys offer advantages for pet health. For example, pet toys may aid in dental health, physical exercise, and mental stimulation of a pet. Pet toys are available in many different shapes, sizes and variety of materials. With respect to dogs, some exemplary pet toys are chew toys that have a general dumbbell or barbell shape. The shape of dumbbell or barbell dog toys serves as an effective dental aid. As dogs chew and play with these toys, the barbell's design massages their gums and helps clean their teeth. The textured surface promotes oral hygiene, reducing plaque buildup and supporting overall dental health.

The shape of the toy allows dogs to grip and manipulate the toy, promoting active movement and muscle engagement. This is beneficial as encouraging dogs to engage in play with toys contributes to their physical well-being. Regular exercise is essential for maintaining a healthy weight, muscle tone, and cardiovascular fitness.

Additionally, dogs benefit from mental stimulation as much as physical exercise. Toys engage dog's minds, preventing boredom and providing an outlet for natural instincts. Dogs can explore different angles and textures, keeping their brains active and entertained.

Some pet toys incorporate the delivery of a treat to a dog. This further enhances the dog's desire to interact with the toy. However, when delivering the treat to the pet toy, the treat is dispensed irrespective of the location at which the dog is playing with the toy. This can result in a mess. For example, if the treat is peanut butter and the pet toy delivers peanut butter to the dog, the peanut butter can inadvertently make a mess in carpet upon which the dog is playing.

### SUMMARY OF THE INVENTION

Although many pet toys are currently available, there is still room for improvement. Delivering a treat to the dog can be somewhat difficult when the treat is stored in the internal volume or compartment of the toy and the pet owner wants to ensure that the pet toy remains on a surface that is easy to clean (e.g., tile floors instead of carpet). Thus, a need exists for an improved configuration for delivering a treat to a pet, such as a dog, via a pet toy that inhibits rolling onto an undesired surface. The present disclosure addresses this issue among other needs for improving a pet toy that can deliver a treat but also encourage the pet toy to remain in a preferred location.

In yet another aspect, another exemplary embodiment of the present disclosure may provide in combination, a pet toy and a plunger, the combination comprising: a pet toy body defining a cavity, and one or more holes in open communication with the cavity, and the holes extend radially from a longitudinal axis through the pet toy body; a distal end of the plunger having a diameter that complements a diameter of the cavity; wherein a pet toy body is adapted to receive a pet treat within the cavity; and wherein the distal end of the plunger moves axially along the longitudinal axis through the cavity to expel the pet treat radially or axially outward from the cavity through the plurality of holes to dispose the pet treat on an exterior surface of the pet toy body. This exemplary embodiment or another exemplary embodiment may further include a first enlarged member that defines the first end of the body; a first dimension of the first enlarged member, wherein the first dimension extends through the longitudinal axis and is measured between two different points on a perimeter of the first enlarged member; a second enlarged member that defines the second end of the body; a second dimension of the second enlarged member, wherein the second dimension extends through the longitudinal axis and is measured between two different points on a perimeter of the second enlarged member; and wherein the first dimension is greater than the second dimension that is adapted to cause the pet toy to roll along a curved trajectory as the pet toy rotates about the longitudinal axis. This exemplary embodiment or another exemplary embodiment may further include an elongated central portion of the body that extends along the longitudinal axis between the first enlarged member and the second enlarged member, wherein the elongated central portion defines the cavity therein; and an end opening defined in the body, wherein the end opening is in open communication with the cavity, and the opening permits a treat to be inserted into the cavity, wherein the end opening receives the distal end of the plunger when the treat is to be expelled from the cavity.

In yet another aspect, another exemplary embodiment of the present disclosure may provide a method of dispensing a pet treat from a pet toy, the method comprising: placing the pet treat into a cavity defined by a central portion of the pet toy, wherein a longitudinal axis extends centrally through the cavity, and wherein the cavity has a diameter, and the central portion defines one or more holes that extend radially relative to the longitudinal axis through the central portion; aligning a plunger axially along the center longitudinal axis; moving a distal end of the plunger axially along the center longitudinal axis through an end opening defined by the pet toy, wherein the distal end of the plunger has a diameter that complements the diameter of the cavity; expelling the pet treat radially or axially relative to the longitudinal axis through the one or more holes defined in the pet toy body; and disposing the pet treat on an exterior surface of the central portion. This exemplary embodiment or another exemplary embodiment may further include rotating the pet toy about the longitudinal axis; moving the pet toy along a curved trajectory as the pet toy rotates about the longitudinal axis, wherein moving along the curved trajectory is accomplished by the pet toy having two enlarged members having differing diameters, wherein the first enlarged member is located at one end of the central portion and the second enlarged member is located at the other end of the central portion.

In yet another aspect, another exemplary embodiment of the present disclosure may provide a pet toy comprising: a body extending between a first end and a second end along a center longitudinal axis; a first enlarged member that defines the first end of the body; a second enlarged member that defines the second end of the body, wherein the second enlarged member has an inner surface; a first diameter of the first enlarged member; a second diameter of the second enlarged member, wherein the first diameter is greater than the second diameter which causes the pet toy to roll along a curved trajectory as the pet toy rotates about the center longitudinal axis; an elongated central portion of the body that extends between the first enlarged member and the second enlarged member, wherein the elongated central portion defines a majority of a cavity therein, wherein the elongated central portion has an inner surface; wherein the elongated central portion has an outer diameter that is less than the second diameter such that the pet toy is generally barbell-shaped or dumbbell-shaped; a cavity defined by the inner surface of the elongated central portion and the inner surface of the second enlarged member, and wherein the inner surface of the second enlarged member complements an end of a plunger that is adapted to be inserted axially along the center longitudinal axis through the cavity; and a plurality of openings opening defined in the second enlarged member, wherein the plurality of openings are in open communication with the cavity, and the opening permits a treat stored in the cavity to exit the cavity in response to being ejected by the plunger having a diameter that complements an inner diameter of the elongated central portion, wherein the pet treat is a paste or paste-like material.

This example embodiment or another example embodiment may further provide that the plurality of openings includes a central opening that is coaxial along the center longitudinal axis. This example embodiment or another example embodiment may further provide that the plurality of openings includes a first set of openings arranged as a first ring surrounding the central opening. This example embodiment or another example embodiment may further provide that the plurality of openings includes a second set of openings arranged as a second ring concentrically surrounding the first set of openings.

This example embodiment or another example embodiment may further provide that at least one opening from the plurality of openings includes an outer portion thereof that defines a counterbore. This example embodiment or another example embodiment may further provide that the plurality of openings includes a central opening includes a circular counterbore. This example embodiment or another example embodiment may further provide that the at least one opening is positioned near a perimeter of the second enlarged member and has a trapezoidal counterbore. This example embodiment or another example embodiment may further provide that the counterbore is configured to retain the pet treat therein such that the pet treat does not spill outward beyond the second end of pet toy. This example embodiment or another example embodiment may further provide that there is a counterbore formed in each opening of the plurality of openings, wherein a collective volume the counterbores is less than a volume of the cavity. This example embodiment or another example embodiment may further provide that the collective volume of the counterbores is at most about ⅓ of the volume of the cavity that is adapted to permit at least 3 incremental discharges of the pet treat from the cavity in response to actuation of the plunger without needing to refill the cavity with the pet treat between incremental discharges.

In yet another aspect, another exemplary embodiment of the present disclosure may provide a method for dispensing a pet treat from a pet toy, the method comprising: providing a pet toy comprising a body defining an internal cavity and a plurality of openings formed in the body; loading the internal cavity with a quantity of a treat material sufficient for multiple dispensing operations, wherein the treat material is a paste or paste-like material; actuating a plunger through the internal cavity to incrementally dispense a portion of the treat material through at least one of the openings; allowing a pet to access and consume the dispensed portion of the treat material; and repeating the actuation of the plunger to dispense successive portions of the treat material from the internal cavity without reloading the cavity between dispensing operations.

This example embodiment or another example embodiment may further include moving the plunger a first distance parallel to a longitudinal axis of the body, wherein the first distance is less than a total length of the internal cavity. This example embodiment or another example embodiment may further include discharging a first portion of treat material in response moving the plunger the first distance; and providing the pet toy to the pet after discharging the first portion, wherein the first portion of treat material is adapted to be consumed by the pet. This example embodiment or another example embodiment may further include discharging a second portion of treat material in response to moving the plunger a second distance parallel to the longitudinal axis of the body, wherein the second distance is less than the total length of the internal cavity; providing the pet toy to the pet after discharging the second portion, wherein the second portion of treat material is adapted to be consumed by the pet; and wherein the pet toy is not reloaded with treat material between discharging the first portion and the second portion. This example embodiment or another example embodiment may further include discharging a third portion of treat material in response to moving the plunger a third distance parallel to the longitudinal axis of the body, wherein the third distance is less than the total length of the internal cavity; providing the pet toy to the pet after discharging the third portion, wherein the third portion of treat material is adapted to be consumed by the pet; and wherein the pet toy is not reloaded with treat material between discharging the second portion and the third portion.

This example embodiment or another example embodiment may further include dispensing the treat material through at least one opening from the plurality of openings that are formed in an enlarged member at an end of the pet toy, wherein the enlarged member at least partially defines a barbell configuration of the pet toy.

This example embodiment or another example embodiment may further include dispensing the treat material into a counterbore of the at least one opening.

In yet another aspect, another exemplary embodiment of the present disclosure may provide in combination, a pet toy, a pet treat, and a plunger, wherein the combination comprises: a pet toy body defining a cavity and a plurality of openings in open communication with the cavity; a plunger having a distal end, wherein the distal end of the plunger has an outer diameter that complements an inner diameter of the cavity; wherein the pet toy body receives a pet treat within the cavity, wherein the pet treat is a paste or paste-like material; and wherein the distal end of the plunger moves incrementally through the cavity to incrementally dispense the pet treat outward from the cavity through the plurality of openings.

This example embodiment or another example embodiment may further provide that at least one opening from the plurality of openings has a counterbore, and wherein the distal end of the plunger moves incrementally through the cavity to incrementally dispense the pet treat outward from the cavity to dispose the pet treat in the counterbore.

This example embodiment or another example embodiment may further include a first enlarged member that defines a first end of the pet toy body; a second enlarged member that defines a second end of the pet toy body; wherein the first enlarged member has a diameter that is greater than the second enlarged member to cause the pet toy to roll along a curved trajectory as the pet toy rotates about the longitudinal axis; and wherein the plurality of openings, through which the pet treat is expelled in response to axial movement of the plunger through the cavity, are defined in the second enlarged member that defines the second end of the pet toy body.

In yet another aspect, an example embodiment of the present disclosure may include a pet toy comprising: a body extending between a first end and a second end along a center longitudinal axis; an enlarged member that defines the second end of the body, wherein the enlarged member has an inner surface; an elongated central portion of the body that extends between the first end and the second end, wherein the elongated central portion has an inner surface; a cavity defined by the inner surface of the elongated central portion and the inner surface of the second enlarged member; a plunger having a proximal end and a distal end, wherein the plunger has a length measured from the proximal end to the distal end, wherein the length of the plunger is less than a length of the cavity; and a plurality of openings defined in the second enlarged member at the second end, wherein the plurality of openings are in open communication with the cavity, and the plurality of openings permit a treat stored in the cavity to exit the cavity in response to being ejected by the plunger that is inserted and moved axially through the cavity along the center longitudinal axis and the plunger having a diameter that complements an inner diameter of the elongated central portion, wherein the pet treat is a paste or paste-like material.

### BRIEF DESCRIPTION OF THE DRAWINGS

One or more exemplary embodiment(s) of the present disclosure is set forth in the following description, is shown in the drawings and is particularly and distinctly pointed out and set forth in the appended claims. The accompanying drawings, which are incorporated in and constitute a part of the specification, illustrate various example configurations and methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a front perspective view of a first embodiment of a pet toy.

FIG. 2 is a front elevation view of the first embodiment of the pet toy.

FIG. 3 is a rear elevation view of the first embodiment of the pet toy.

FIG. 4 is a right side elevation view of the first embodiment of the pet toy.

FIG. 5 is a left side elevation view of the first embodiment of the pet toy.

FIG. 6 is a second end plan view of the first embodiment of the pet toy.

FIG. 7 is a first end plan view of the first embodiment of the pet toy.

FIG. 8 is a rear perspective view of the first embodiment of the pet toy.

FIG. 9 is a top perspective view of the first embodiment of the pet toy.

FIG. 10 is a front perspective view of a second embodiment of a pet toy.

FIG. 11 is a front elevation view of the second embodiment of the pet toy.

FIG. 12 is a rear elevation view of the second embodiment of the pet toy.

FIG. 13 is a right side elevation view of the second embodiment of the pet toy.

FIG. 14 is a left side elevation view of the second embodiment of the pet toy.

FIG. 15 is a second end plan view of the second embodiment of the pet toy.

FIG. 16 is a first end plan view of the second embodiment of the pet toy.

FIG. 17 is a rear perspective view of the second embodiment of the pet toy.

FIG. 18 is a top perspective view of the second embodiment of the pet toy.

FIG. 19 is a front perspective view of a third embodiment of a pet toy.

FIG. 20 is a front elevation view of the third embodiment of the pet toy.

FIG. 21 is a rear elevation view of the third embodiment of the pet toy.

FIG. 22 is a right side elevation view of the third embodiment of the pet toy.

FIG. 23 is a left side elevation view of the third embodiment of the pet toy.

FIG. 24 is a second end plan view of the third embodiment of the pet toy.

FIG. 25 is a first end plan view of the third embodiment of the pet toy.

FIG. 26 is a longitudinal cross section view of the third embodiment of the pet toy.

FIG. 27 is a top perspective view of the third embodiment of the pet toy and a plunger that is used therewith to eject a consumable through holes formed in the body.

FIG. 28 is a front perspective view of a fourth embodiment of a pet toy.

FIG. 29 is a rear perspective view of the fourth embodiment of a pet toy.

FIG. 30 is a longitudinal cross section view of the fourth embodiment of the pet toy taken along line 30-30 in FIG. 28.

FIG. 31 is a second end perspective view of a fifth embodiment of a pet toy.

FIG. 32 is a first side elevation view of the fifth embodiment of the pet toy.

FIG. 33 is a second side elevation view of the fifth embodiment of the pet toy.

FIG. 34 is a second end plan view of the fifth embodiment of the pet toy.

FIG. 35 is a first end plan view of the fifth embodiment of the pet toy.

FIG. 36 is a first end perspective view of the fifth embodiment of the pet toy.

FIG. 37 is a longitudinal cross section view of the fifth embodiment of the pet toy.

FIG. 38 is an operational perspective view of the fifth embodiment of the pet toy in combination with a plunger that is sized to move through the cavity of the pet toy.

Similar numbers refer to similar parts throughout the drawings.

### DETAILED DESCRIPTION

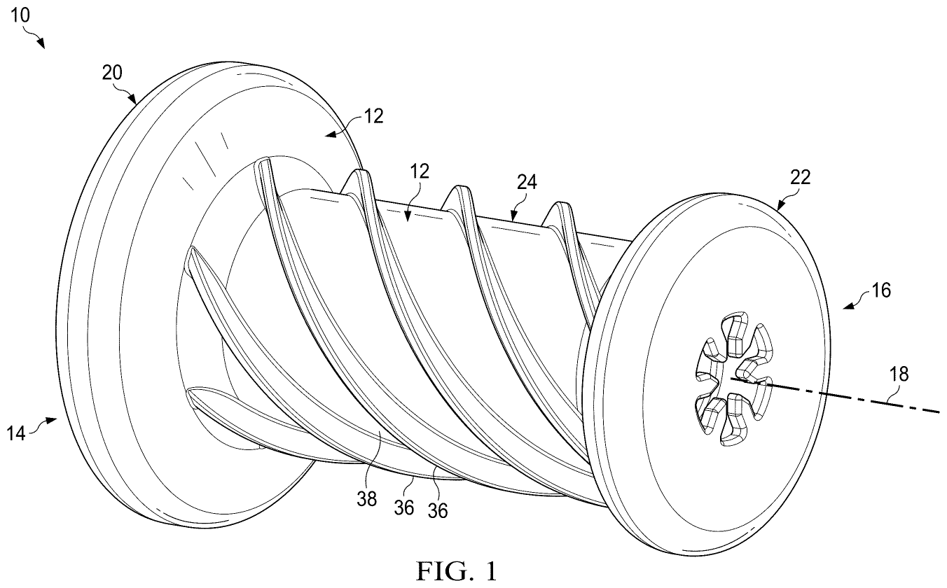

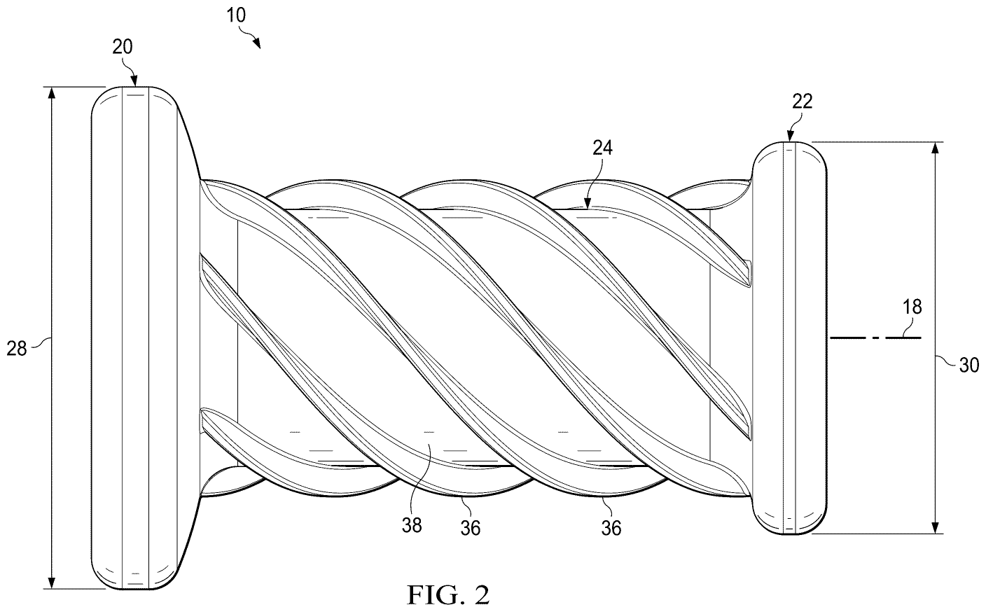

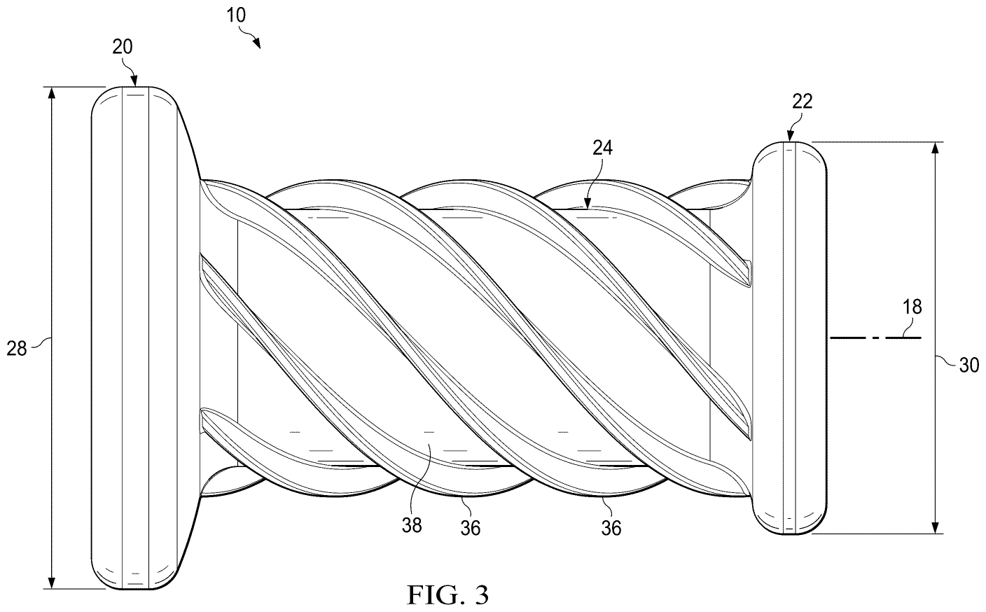

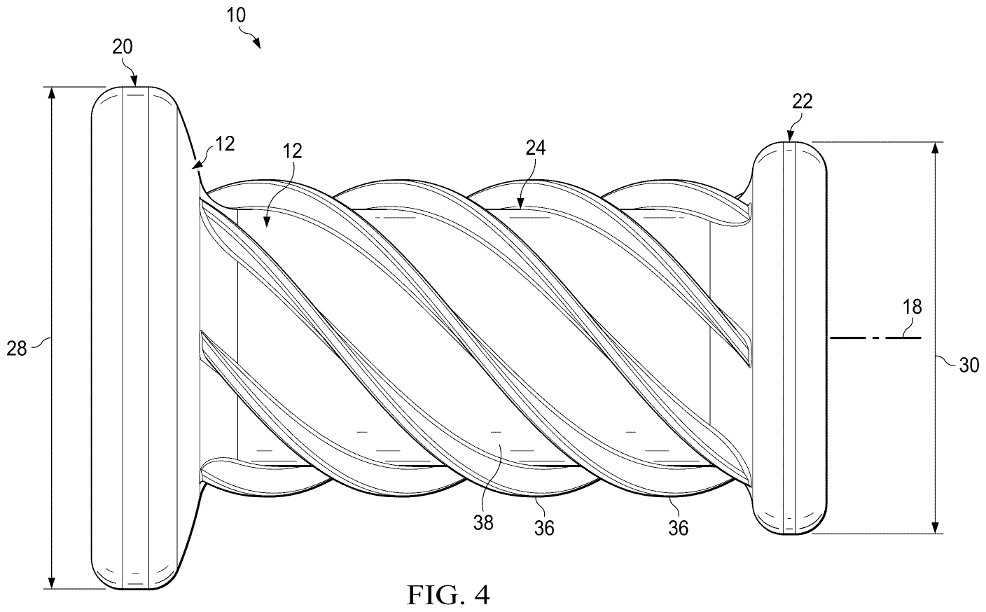

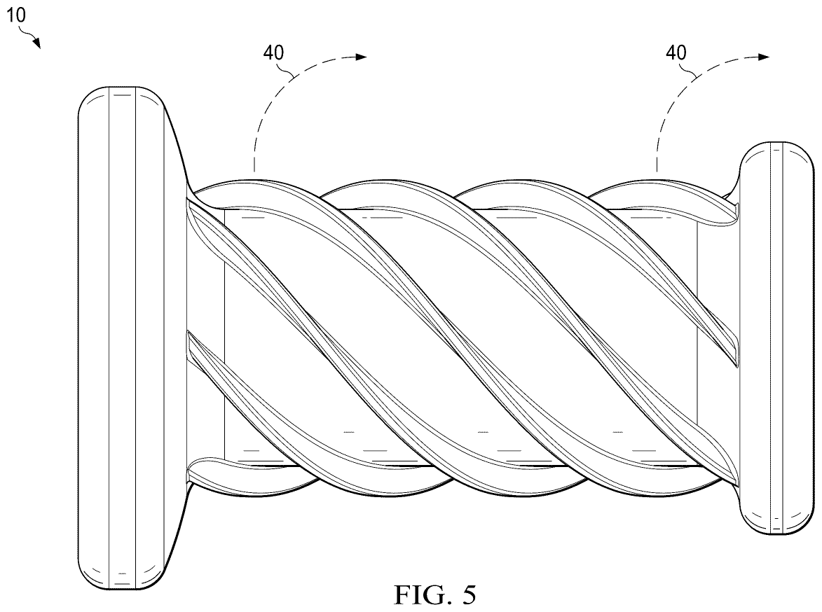

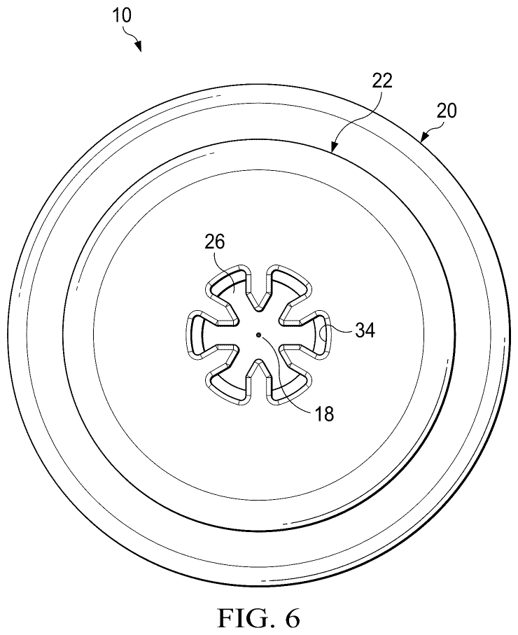

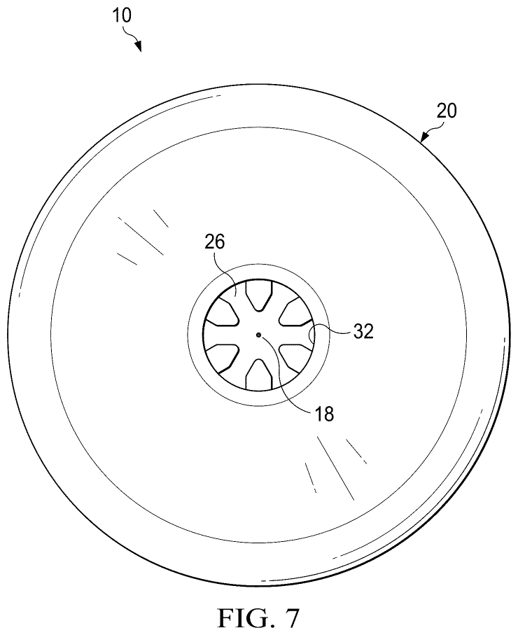

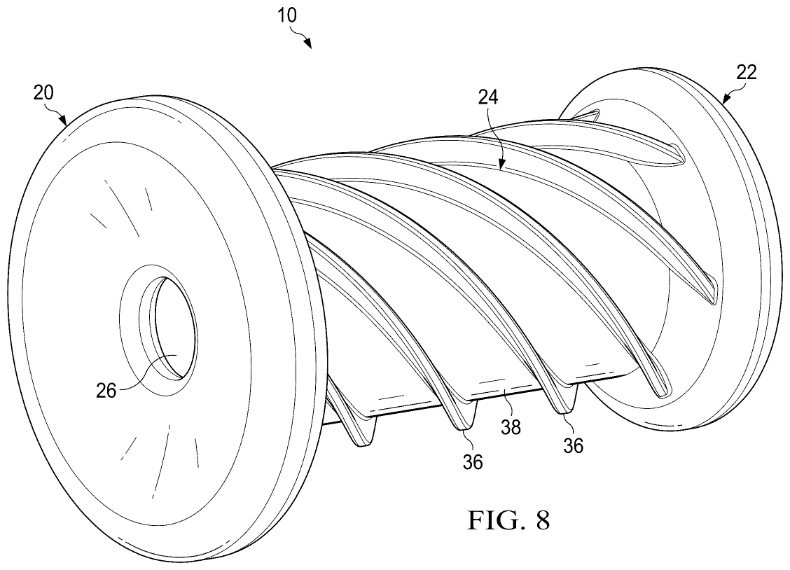

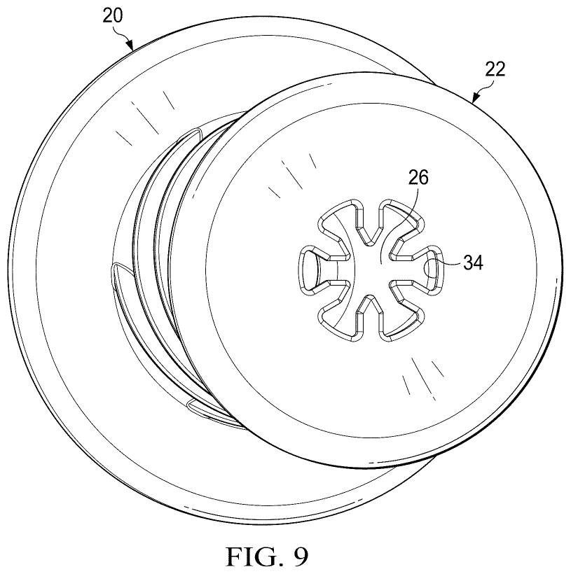

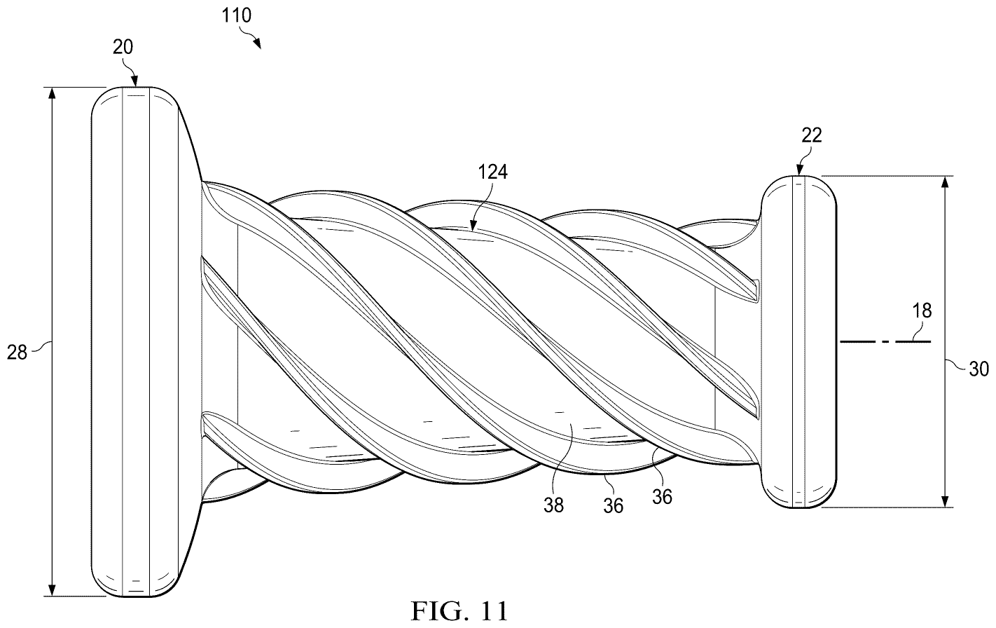

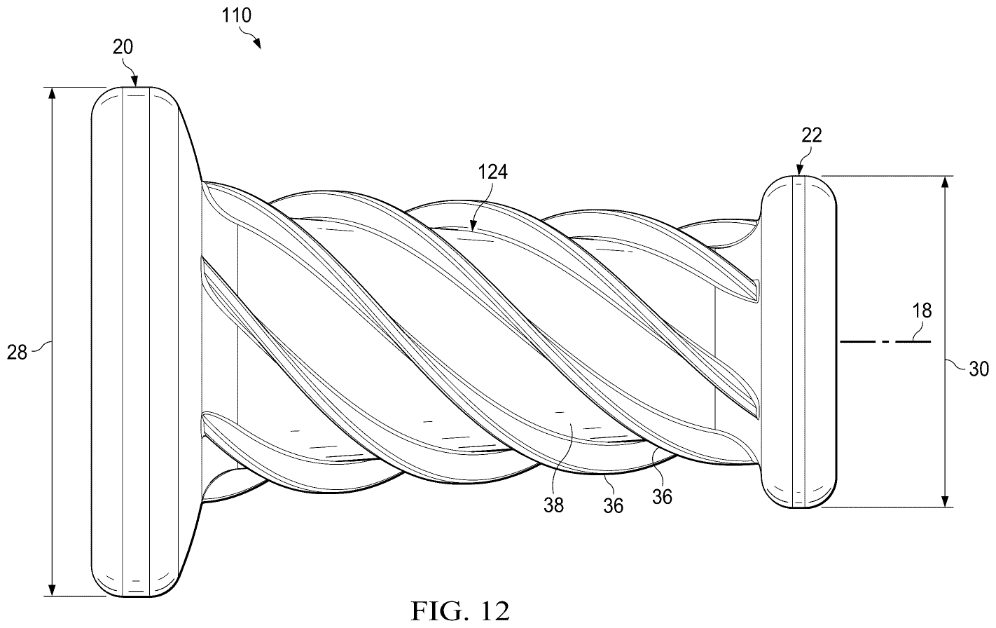

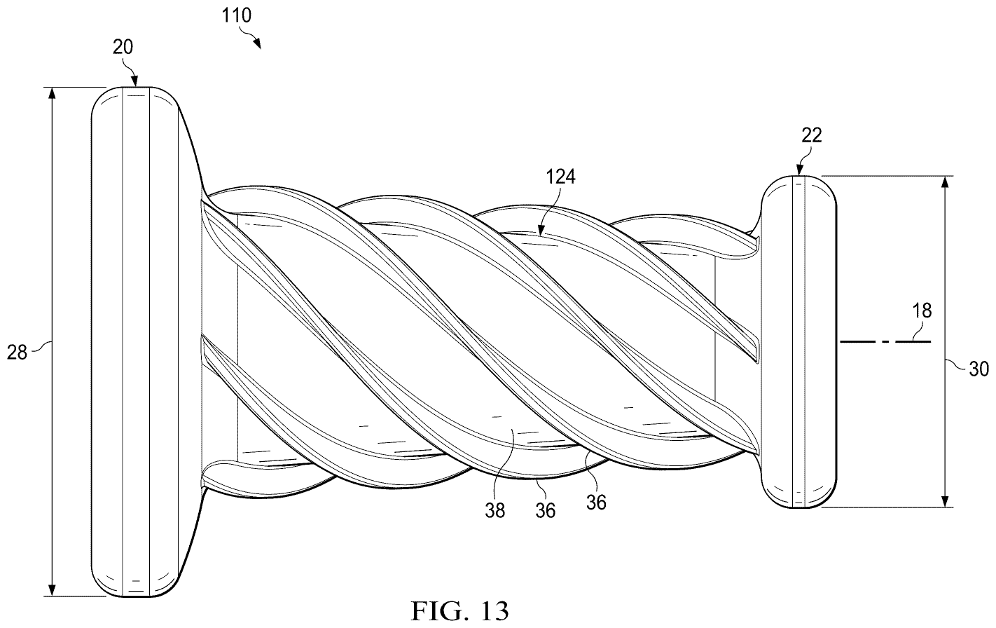

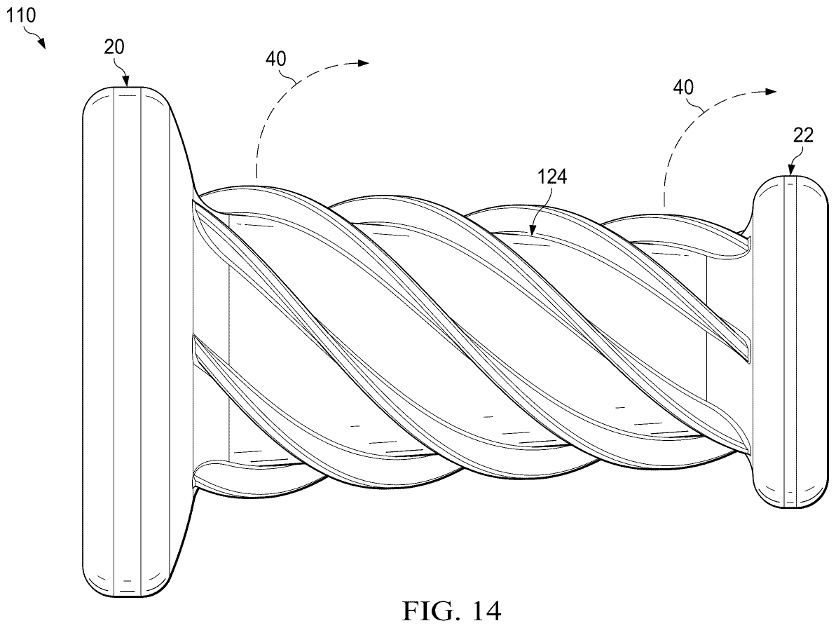

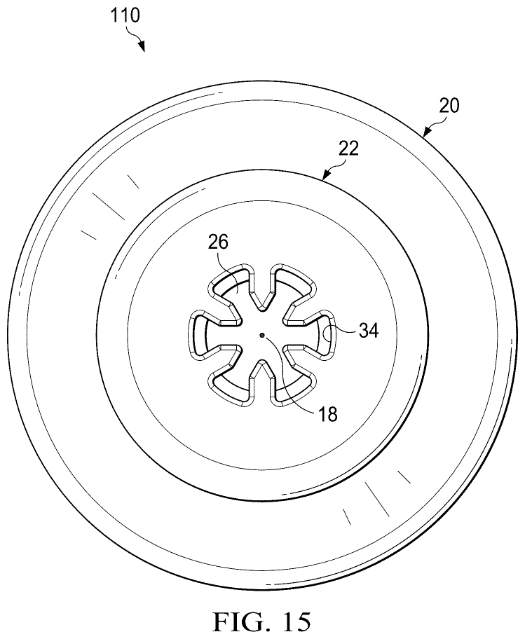

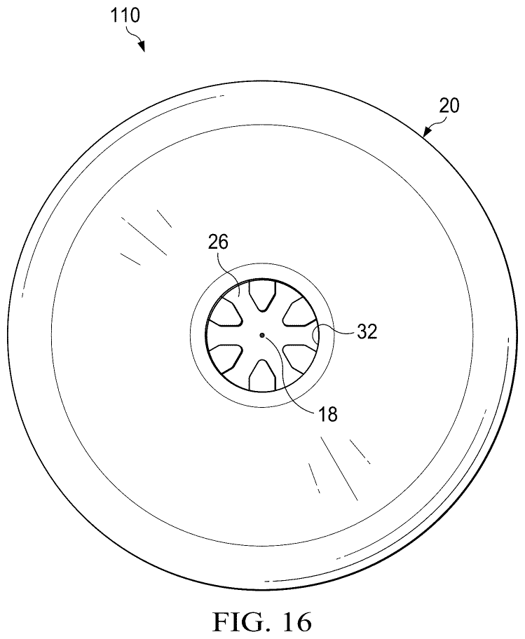

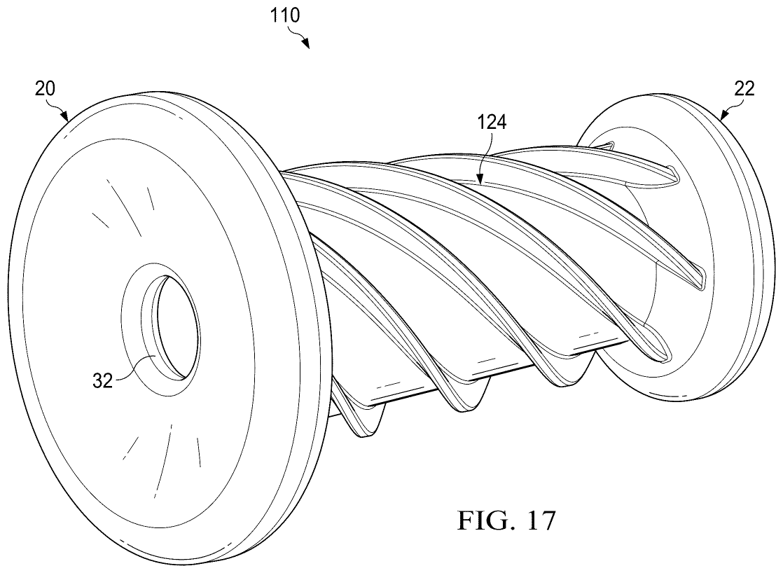

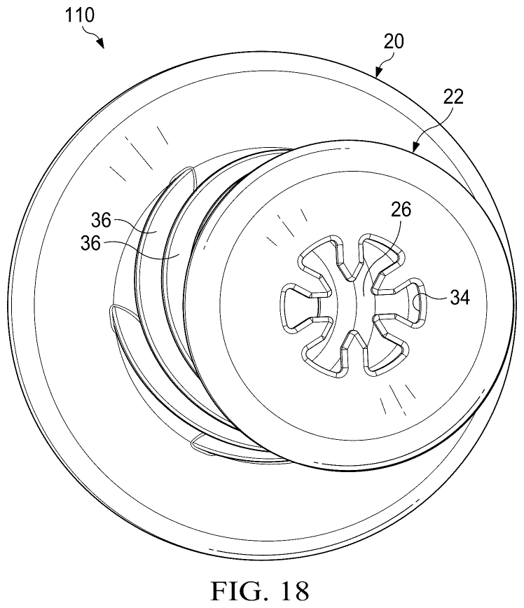

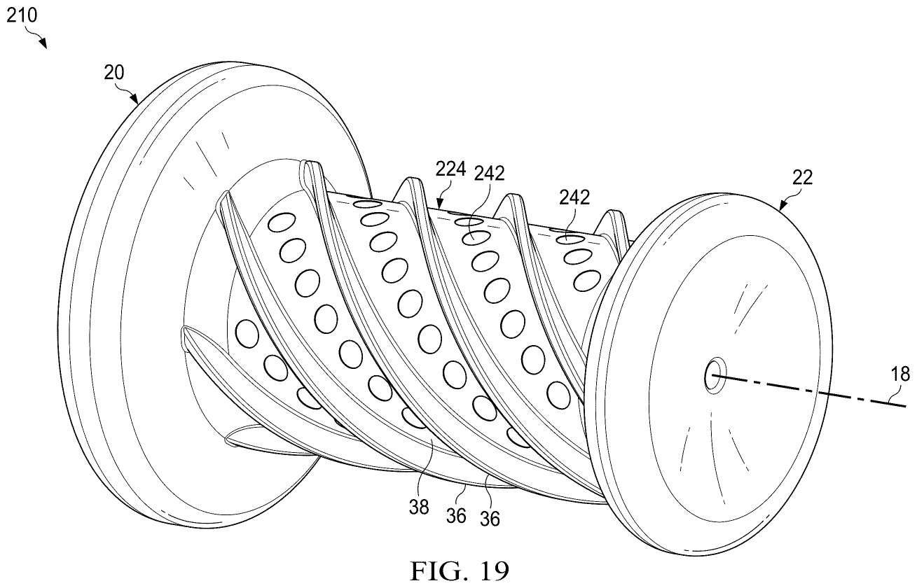

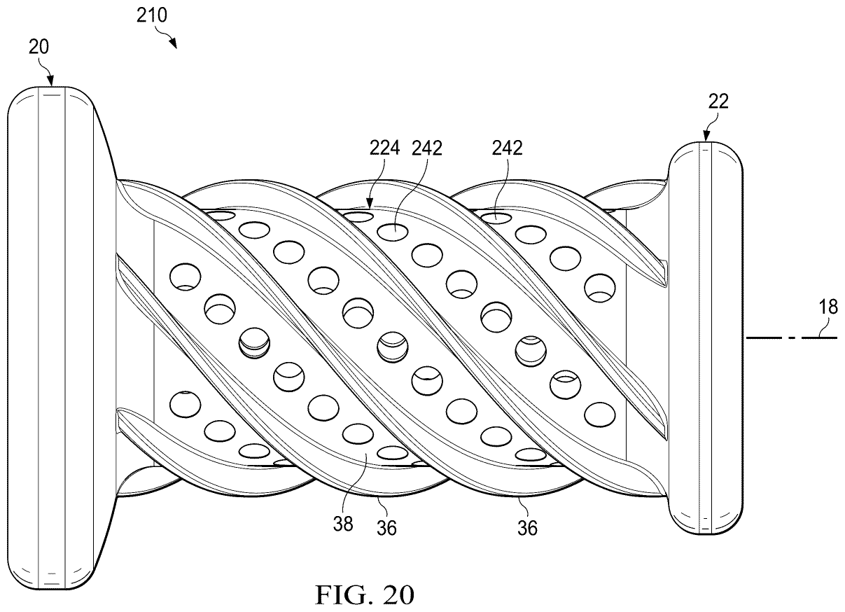

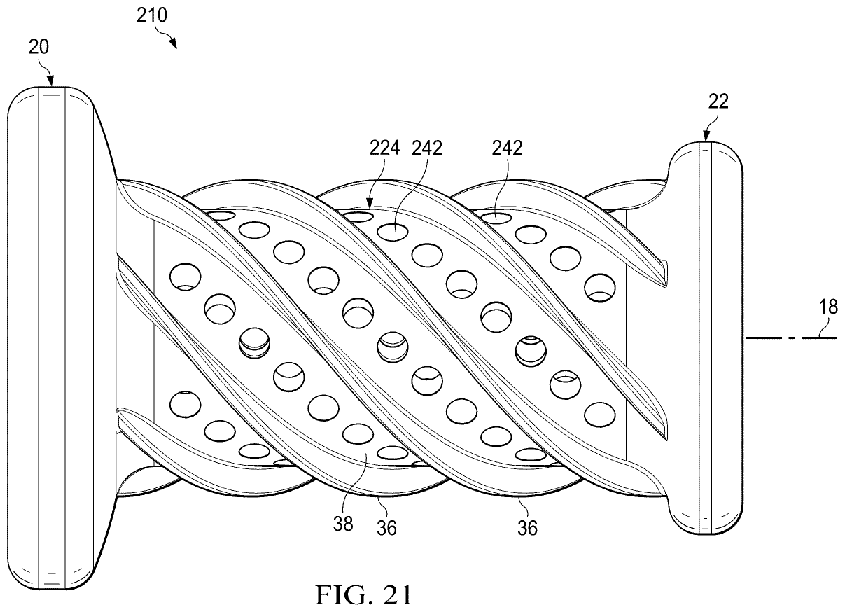

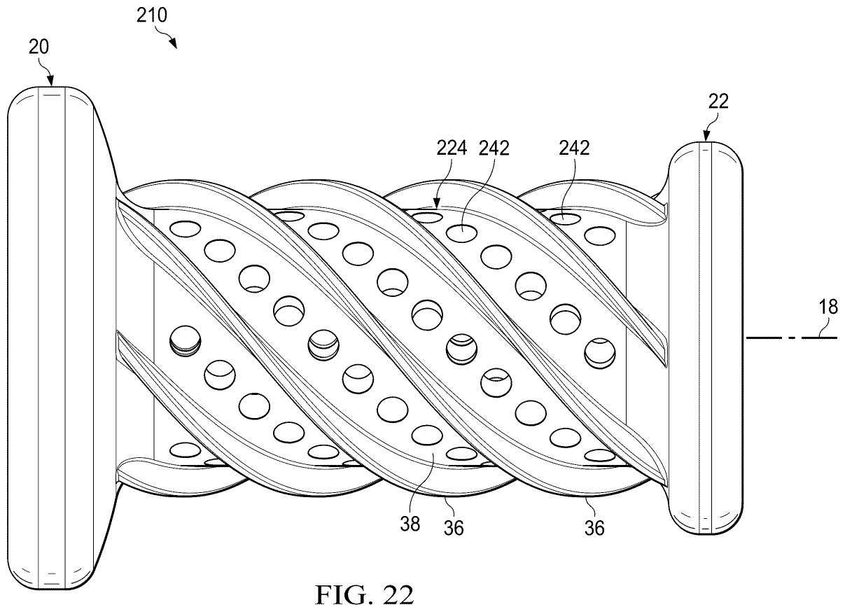

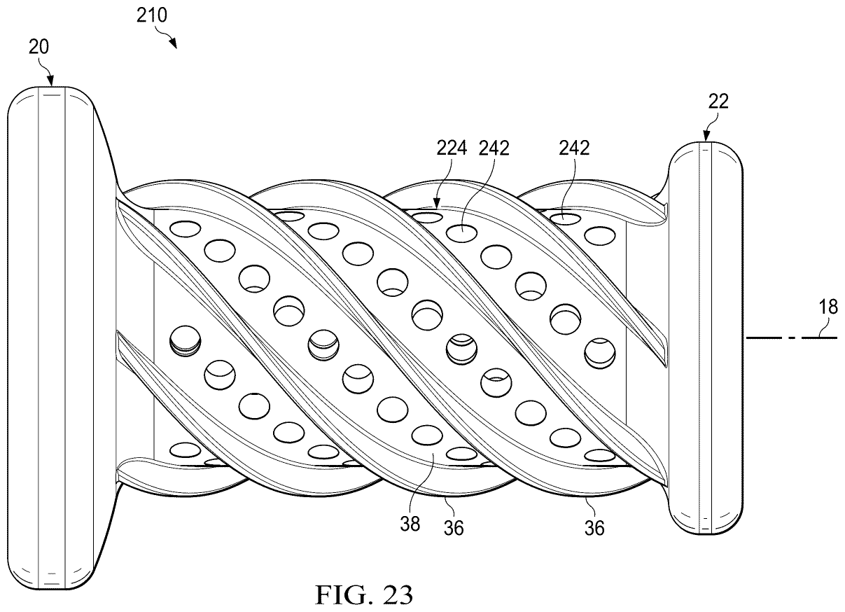

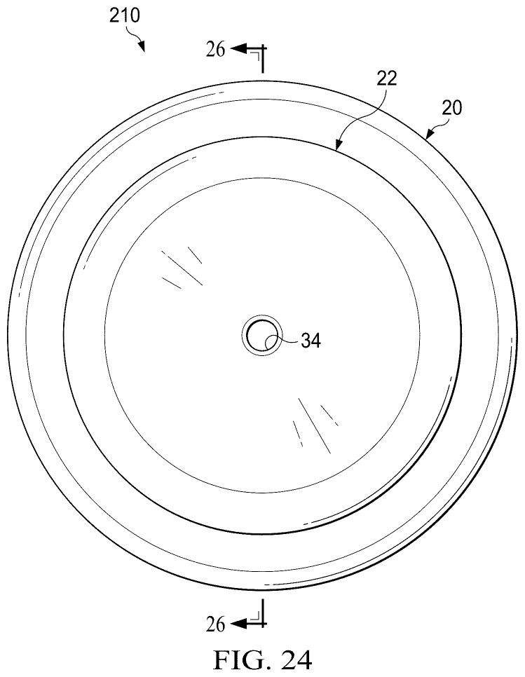

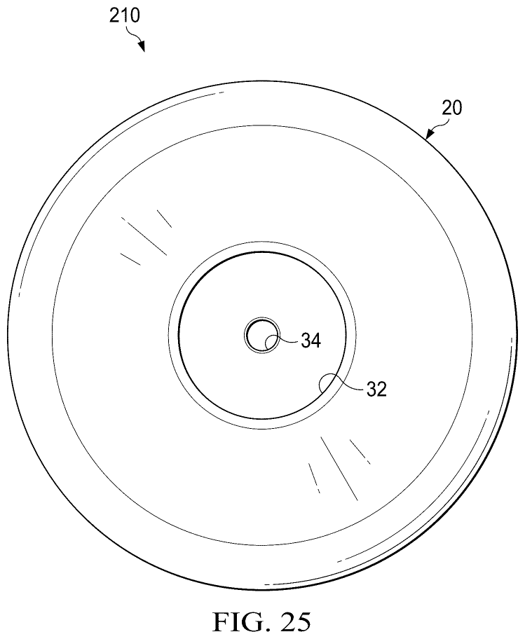

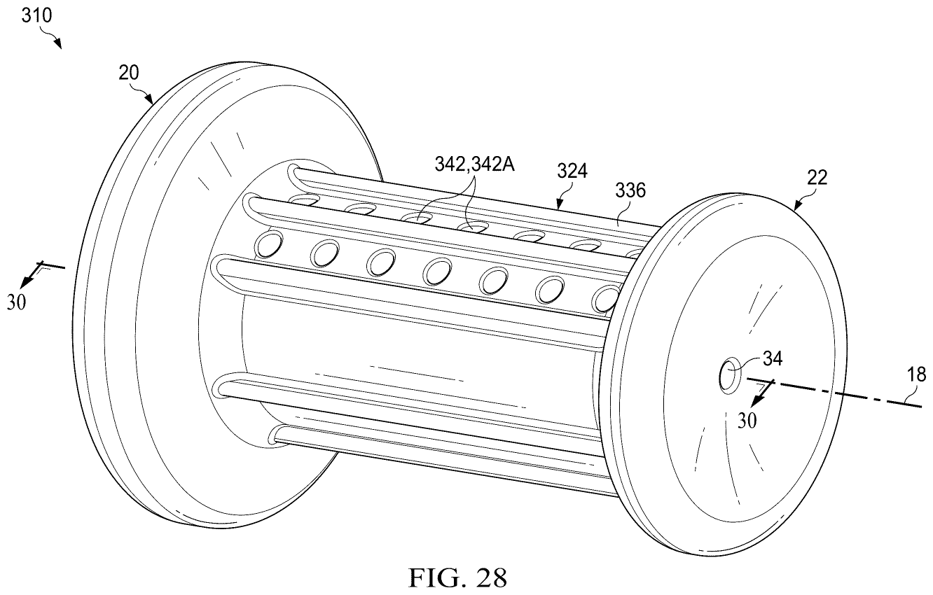

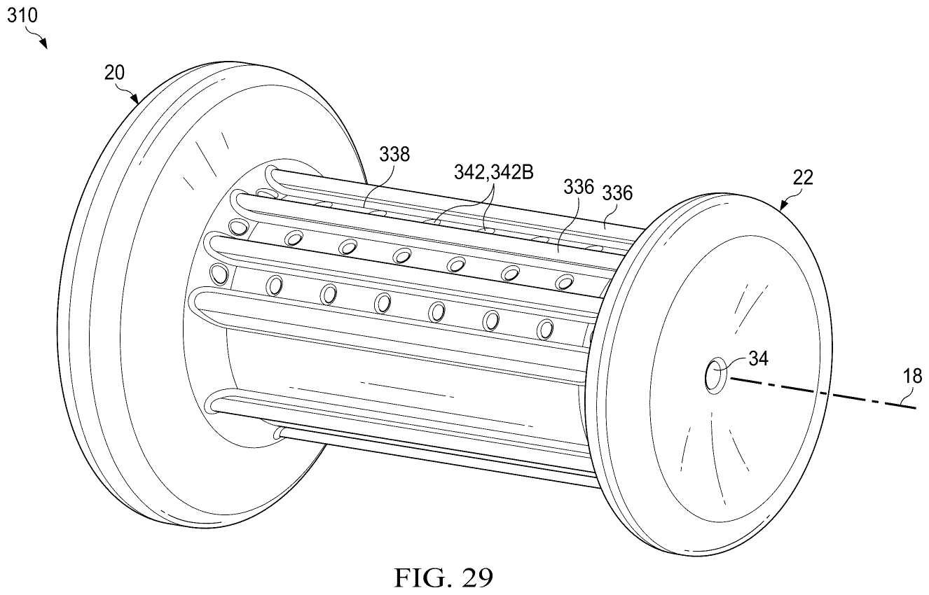

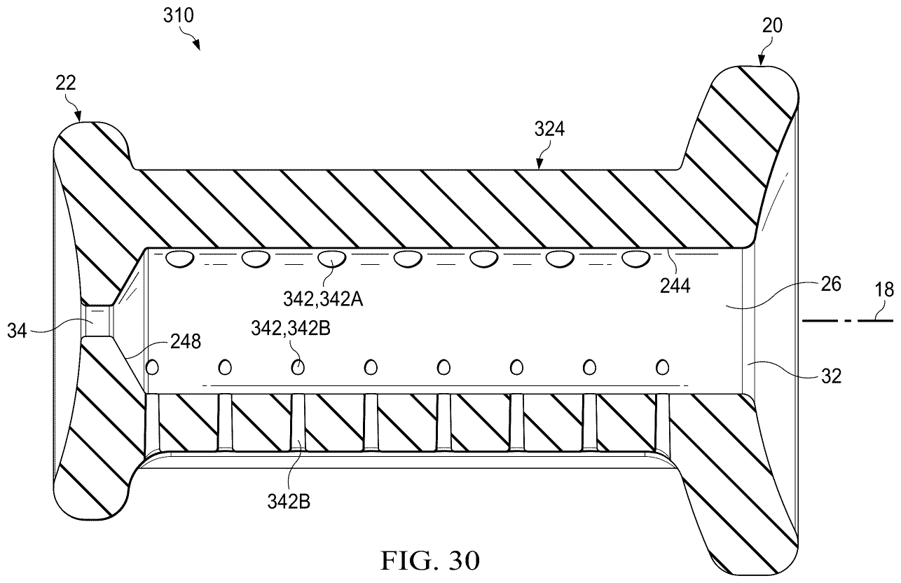

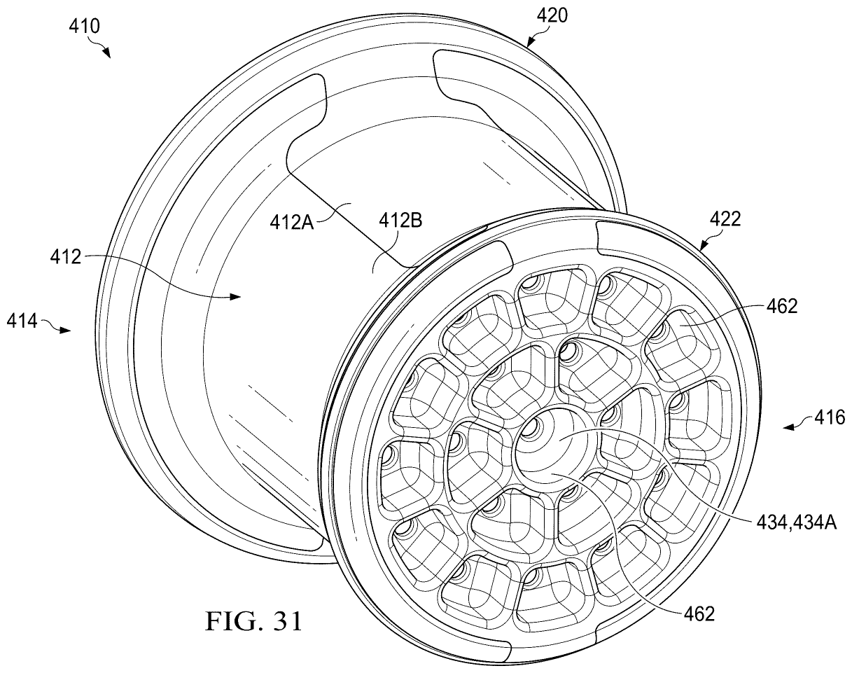

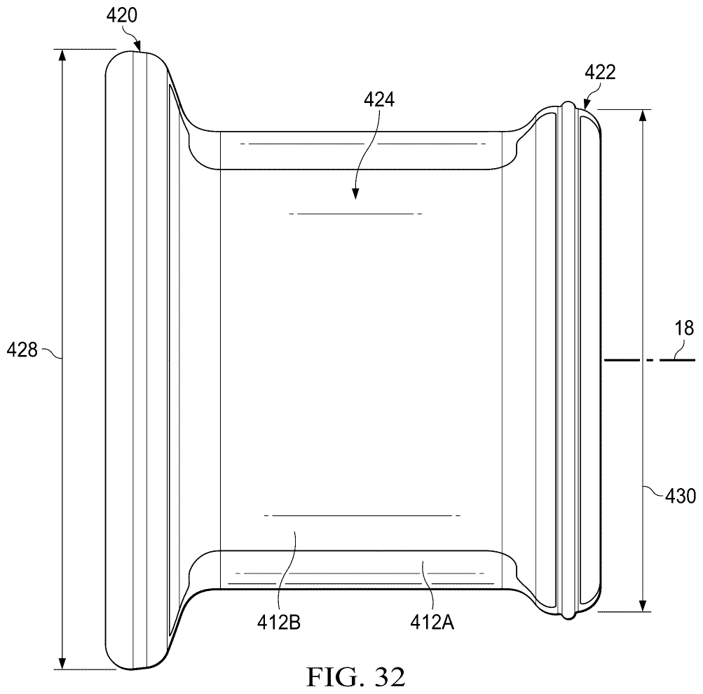

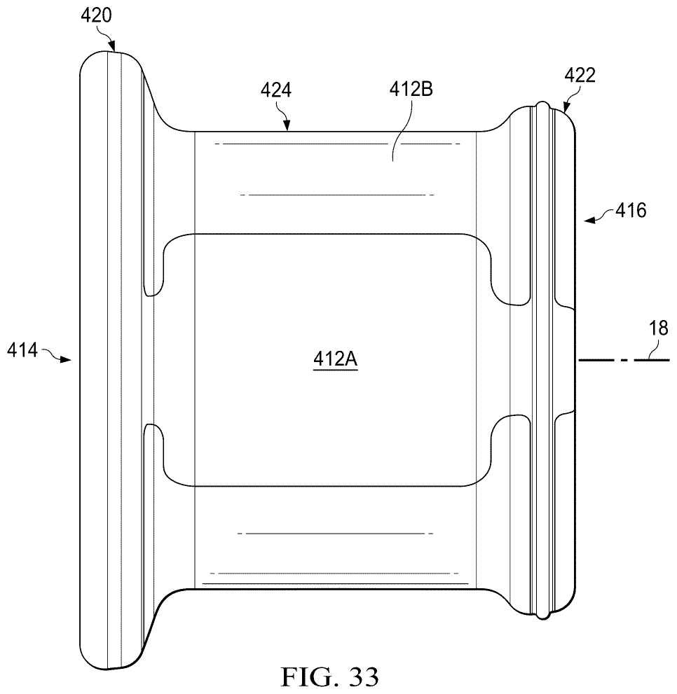

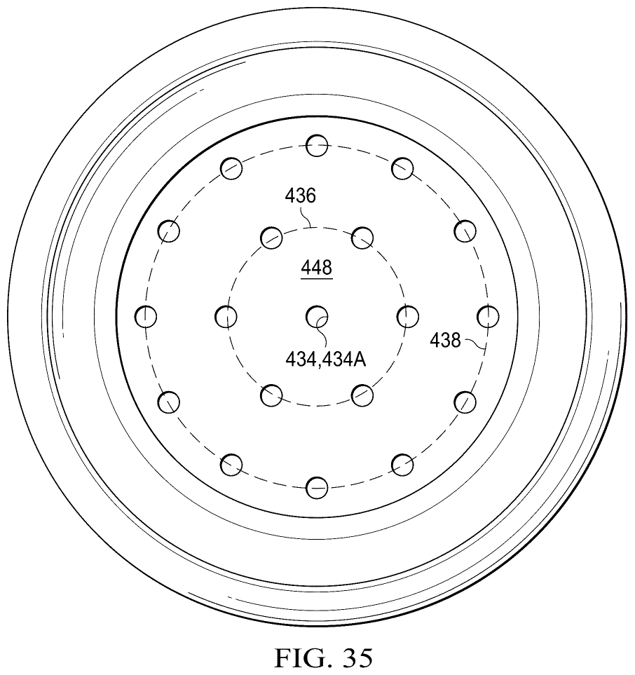

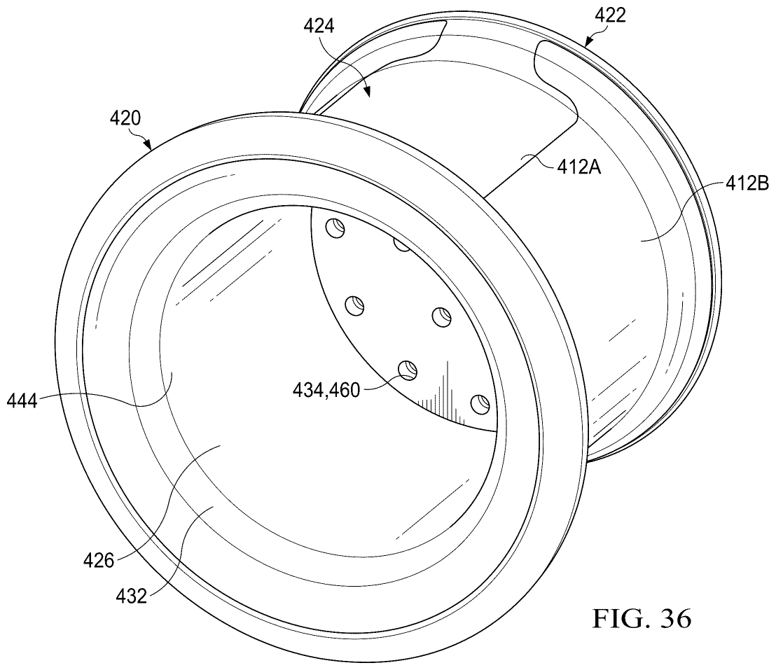

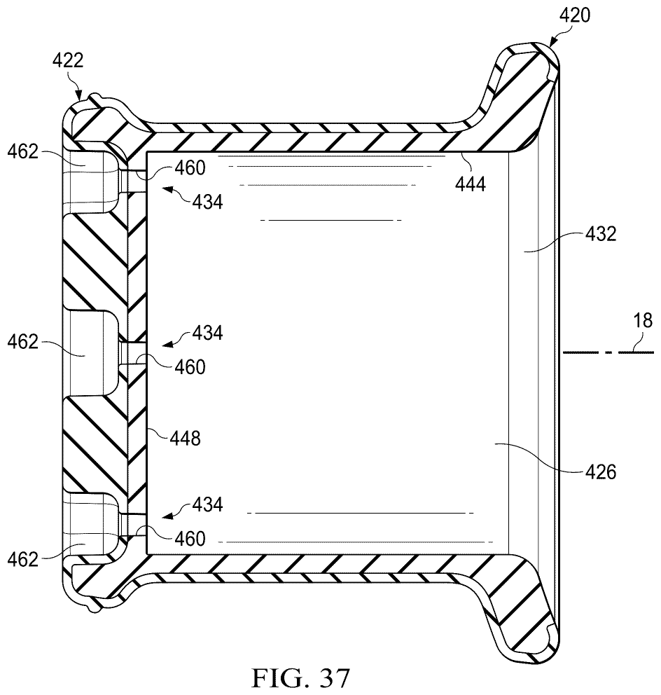

The Figures depict various embodiments of a pet toy. FIGS. 1-9 depict a first embodiment of the pet toy at 10. FIGS. 9-18 depict a second embodiment of the pet toy at 110. FIGS. 19-27 depict a third embodiment of the pet toy at 210. FIGS. 28-30 depict a fourth embodiment of the pet toy at 310. FIGS. 31-38 depict a fifth embodiment of the pet toy at 410. Any of these embodiments may be used in combination with a plunger 250 or plunger 450 so as to define a pet toy system or combination that can be used to eject or expel a pet treat from the pet toy.

Due to the similarities between the various embodiments, reference numerals that are repeated throughout the figures refer to similar parts. Those reference numerals may be described with respect to another embodiment, but for brevity may not be repeated in the description of that embodiment. However, it is to be understood that components from one embodiment may be present or claimed in another embodiment.

FIGS. 1-9 depict that pet toy 10 includes a body 12. The body 12 may be generally shaped as a dumbbell or barbell having enlarged ends and an elongated center portion extending between the enlarged ends. Although this particular embodiment is generally dumbbell-shaped or barbell-shaped, other shapes are entirely possible as described herein.

The body 12 of the pet toy 10 may be a unibody that is integrally extruded, molded, printed, or additively manufactured, removably machined, or formed as a unitary, monolithic member substantially fabricated from a flexible, semi-flexible or semi-rigid, manmade or natural, material. The body 12 of the pet toy 10 may be formed from an elastomeric material or rubber material configured to withstand deformation upon chewing or bending by the pet (i.e., a dog). In one example, polymers, such as silicone, plastic (polypropylene or PVC), rubber, or nylon may form a substantial majority of the components or elements used to fabricate the body of the pet toy and the various components integrally formed, molded, or extruded therewith. Silicone is a polymerized siloxane compound, consisting of chains made of alternating silicon (Si) and oxygen (O) atoms. While most industrial polymers contain carbon in their backbones, silicones are unique “inorganic” polymers. Silicones are known for their chemical inertness, resistance to water and oxidation, stability at extreme temperatures, flexibility, and heat resistance. Plastics are polymeric materials with diverse properties. They can be molded or shaped due to their plasticity, which combines low density, low electrical conductivity, transparency, and toughness. Some exemplary commodity resins include high-volume, low-cost plastics such as polyethylene, polypropylene, polyvinyl chloride (PVC), and polystyrene. Natural rubber, also known as latex, consists of polymers of the organic compound isoprene (C₅H₈). It contains minor impurities of other organic compounds. Natural rubber is stretchable, resilient, and waterproof. The pet toy body should withstand typical bite forces or chewing forces imparted from a dog that interacts with the pet toy with the dog's mouth.

In one particular embodiment, the body 12 of the pet toy 10, when crafted from nylon, exhibits specific properties that make it suitable for pet interaction. Nylon is a synthetic polymer known for its strength, durability, and flexibility. It belongs to the family of polyamides and is commonly used in various applications due to its favorable properties. Nylon consists of repeating units linked by amide bonds. It contains carbon (C), hydrogen (H), oxygen (O), and nitrogen (N) atoms in its backbone. Unlike natural rubber, nylon is an inorganic polymer, meaning it lacks carbon-carbon (C—C) bonds in its backbone. Instead, it contains amide (C—N) linkages. Nylon is robust and can withstand mechanical stress, including biting forces from pets. Yet, it remains flexible even under strain, making it suitable for pet toys. Nylon can be modified to have a textured surface for better grip during play. Nylon can be dyed in various colors to enhance visual appeal.

While it is contemplated that the body 12 of the pet toy 10 and its additional components described herein are uniformly and integrally extruded, molded, or formed, it is entirely possible that the components of the pet toy body be formed separately from alternative materials as one having routine skill in the art would understand. Furthermore, while the components of the body 12 of the pet toy 10 are discussed below individually, it is to be clearly understood that the components and their corresponding reference elements of the pet toy body are portions, regions, or surfaces of the body 12 and all form a respective element or component of the unitary pet toy body. Thus, while the components may be discussed individually and identified relative to other elements or components of the body 12 of the pet toy 10, in this exemplary embodiment, there is a single pet toy body 12 having the below described portions, regions, or surfaces.

The body 12 of the pet toy 10 extends between a first end 14 and a second end 16 along a center longitudinal axis 18. A first enlarged member 20 defines the first end 14 of the body 12. A second enlarged 22 member defines the second end 16 of the body 12. The elongated central portion 24 of the body 12 extends between the first enlarged member 20 and the second enlarged member 22. The elongated central portion 24 defines a cavity 26 therein. There is at least one opening or hole defined in the body. The at least one opening is in open communication with the cavity, and the opening permits a treat stored in the cavity to exit the body 12. In one embodiment, the opening is formed in one of the enlarged members 20 or 22. In another embodiment, one opening is formed in each of the enlarged members 20 and 22. In other embodiments, the opening or hole extends radially through the elongated central portion 24 of the body 12.

There is a first dimension 28 of the first enlarged member 20. The first dimension 28 extends through the center longitudinal axis 18 and is measured between two different points on a perimeter of the first enlarged member 20. In one embodiment, the first dimension 28 is a diameter when the first enlarged member 20 has a circular profile. However, the dimension 28 may not be a “diameter” should the first enlarged member 20 have a profile shape that is different from a circular profile.

There is a second dimension 30 of the second enlarged member 22. The second dimension 30 extends through the center longitudinal axis 18 and is measured between two different points on a perimeter of the second enlarged member 22. In one embodiment, the second dimension 30 is a diameter when the second enlarged member 22 has a circular profile. However, the dimension may not be a “diameter” should the second enlarged member 22 have a profile shape that is different from a circular profile.

In one particular embodiment, the first dimension 28 is greater than the second dimension 30. The advantage of having the first dimension 28 being different or greater than the second dimension 30 is that it causes the pet toy 10 to roll in a circle (e.g., along a curved trajectory) when the pet toy rotates about the longitudinal axis 18. This causes the pet toy 10 to remain within a general area bound by the rolling path. This is beneficial for pet owners so that the pet toy 10 does not roll away during use/play into another area of the home that the pet owner does not want the pet to take the toy. For example, the pet toy 10 will roll in a circle on a tile floor and will not inadvertently roll away onto a carpeted area.

More specifically, when the two enlarged members 20 and 22 that have differing diameters are connected by the elongated central portion 24, which acts as an axle, the pet toy 10 will exhibit unique rolling behavior. Namely, as one of the enlarged member rolls, a point on its perimeter traces out a specific path. This path is called a cycloid. Due to the different diameters, the two enlarged members exhibit different cycloid curves. The different cycloid curves cause the pet toy to roll along a curved trajectory in a circular motion (when viewed from above). Particularly, when the pet toy 10 rolls, the larger enlarged member (i.e., the first enlarged member 20) travels a longer distance (circumference) in one revolution compared to the smaller enlarged member (i.e., the second enlarged member 22). Since the first and second enlarged members 20 and 22 are connected by the elongated central portion 24, they all rotate together. However, due to their differing diameters or circumferences, the enlarged members 20 and 22 experience different angular displacements during each rotation. The larger enlarged member (i.e., the first enlarged member20) covers a larger angle (i.e., more radians) than the smaller enlarged member (i.e., the second enlarged member 22). This difference in relative motion causes the pet toy 10 to veer off its straight path when rolling and rotating about the axis 18. The combined effect of the differing angular displacements results in a curved trajectory 40 for the pet toy 10 as it rolls. The pet toy 10 tends to turn toward the side with the smaller enlarged member (i.e., the second enlarged member 22).

The different sizes of the first enlarged member 20 and the second enlarged member may establish a ratio of the first dimension 28 to the second dimension 30. In one embodiment, the ratio of the first dimension 28 to the second dimension 30 is at least 1.05:1. In another embodiment, the ratio of the first dimension to the second dimension, is in a range from about 1.05:1 to about 4:1. These dimensions and ratios are not mere matters of design choice. Rather, it has been determined that the embodiments that utilize this ratio can optimize the rolling of the pet toy 10 along a curved path or trajectory 40 that permits a sufficient amount of rolling to stimulate the dog but still sufficiently maintain or keep the pet toy 10 in a desired area during usage by the pet. In one specific embodiment, the ratio of the first dimension 28 to the second dimension 30 is 41:32. When the ratio is 41:32, the first dimension 28 is 82 units (i.e., millimeters) and the second dimension is 64 units (i.e., millimeters). These units show that one particular embodiment has a ratio of the first dimension 28 to the second dimension 30 that is about 4:3 (i.e., 1.33:1).

Although the curved trajectory 40 is imparted based on the different dimensions 28 and 30, it is also possible to introduce an oscillatory movement into the curved trajectory 40. This would be accomplished by making one of the enlarged members have an oval profile, such that it acts as a cam, when the other enlarged member is circular. In this example, the second enlarged member 22 has an oval (elliptical) profile and a smaller diameter dimension 30. The first enlarged member 28 has a larger circular profile. As the pet toy 10 moves forward, the larger circular enlarged member 20 covers more ground per rotation than the smaller oval member 22. The centripetal acceleration acts toward the center of rotation for both members 20 and 22. However, due to the differing circumferences, the smaller oval member 22 experiences a shorter centripetal acceleration than the larger circular member 20. The combination of these effects results in a curved path for the entire pet toy 10. Additionally, the oval shape of the second enlarged member 22 introduces an oscillation during the curved movement. As the pet toy 10 rolls, the smaller oval shaped member 22 has varying centripetal acceleration that causes it to oscillate slightly, creating a wavy motion superimposed on the curved trajectory 40. The movement of pet toy 10 tends to veer toward the side with the smaller oval member 22, leading to a pet-stimulating interplay of curved trajectory 40 and oscillations. Alternatively, both enlarged members 20 and 22 could have oval profile to impart the oscillations during the rolling of the pet toy 10.

In the exemplary embodiment, the first and second enlarged members 20 and 22 are disc-like enlarged regions that have an exterior surface. In one embodiment, the exterior surface of the first and second enlarged member is generally convex in shape and the interior surface is generally concave in shape. Each of the first and second enlarged members 20 and 22 also have outermost edges, and outermost surfaces. The first enlarged member 20 may define an opening 32 that is in open communication with the cavity 26 of the elongated central portion 24. This exemplary opening is free of any lobes or other obstructions and is simply generally circular in shape.

The second enlarged member 22 may also define an opening 34 that is in open communication with the internal cavity 26. An edge defining the opening 34 may have any geometric shape. In one particular example, the edge may include a plurality of connected sections that define a star-shaped opening. Star-shaped opening may be defined by a generally circular peripheral edge that is periodically interrupted by a plurality of lobes that extend inwardly toward longitudinal axis. The star-shaped opening is illustrated as including six lobes. However, it is entirely contemplated that the edge defining the opening 34 may have any shape suitable to fit pet treats therethrough. For example, instead of a star-shaped opening being defined by the star-shaped edge, the opening may simply be circular in shape. Alternatively, the opening 34 may be a simple circular shape, as shown in the other embodiments herein.

The elongated central portion 24 has a narrower diameter than the enlarged members 20 and 22. The elongated central portion 24 extends between the enlarged members. The elongated central portion 24 may comprise a wall that is configured to include a plurality of ridge flights 36 that extend radially outward relative to axis 18 from the outer surface of the elongated central portion 24. The ridge flights 36 spirally wind or helically wind around the longitudinal axis 18. In the shown embodiment, the number of ridge flights 36 on the elongated central portion is between 3 flights and 9 flights. There may be an interstitial space 38 located between two adjacent ridge flights 36.

In one exemplary embodiment, the angular rotation of each of the ridge flights may be approximately 180° around the longitudinal axis 18 along the length of the elongated central portion 24. For example, a first end of one of one ridge flight 36 may begin at one side of the elongated central portion near the first enlarged member 20. That ridge flight 36 may spiral approximately 180° around the longitudinal axis 18 along the length of the elongated central portion 24 such that a second end of that ridge flight 26 terminates at an opposite side of the elongated central portion 22 near the second enlarged member 22. In other embodiments, the ridge flights may spiral more than 180° around the longitudinal axis 18 along the length of the elongated central portion 24. For example, the ridge flights 36 may spiral about 270°, 360°, 450°, 540°, 630°, 720°, 810°, 900°, 990°, 1080° or more around the longitudinal axis 18 along the length of the elongated central portion 24.

In the first embodiment, the elongated central portion 24 is cylindrical. There is an exterior wall of the elongated central portion 24 that is oriented parallel to and concentric with longitudinal axis 18 along its entire length between the first enlarged member 20 and the second enlarged member 22.

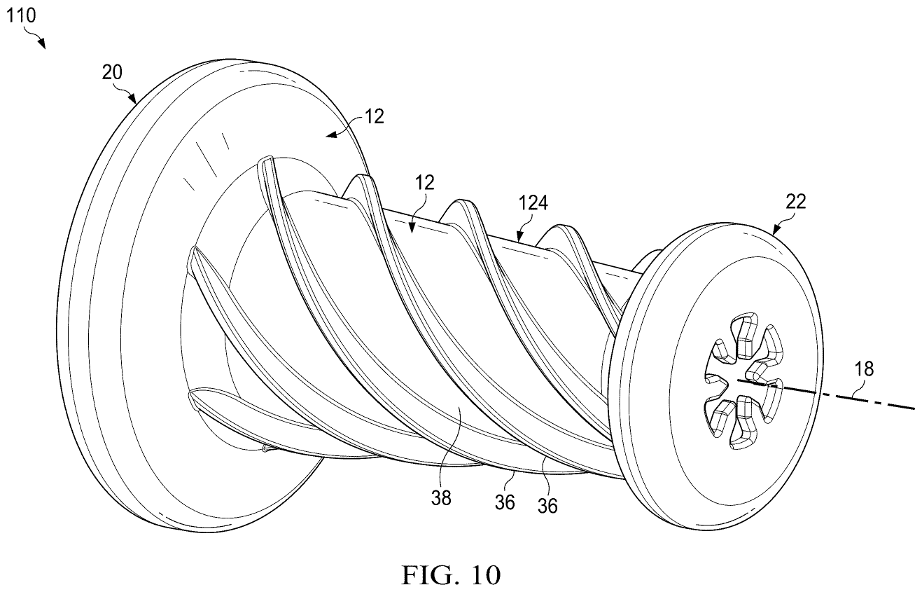

FIGS. 10-18 depict the second embodiment of the pet toy 110. As mentioned previously, components in the pet toy 110 that have similar reference elements as the pet toy 10 are the same. It is seen that that pet toy 110 is similar to the pet toy 10 except that the elongated central portion 124 tapers from the first end to the second end.

In the second embodiment of pet toy 110, the elongated central portion 124 is shaped as a conical cylinder. A conical cylinder is a three-dimensional shape known as an inverted frustum. It is formed when the vertex of a cone is cut by a plane parallel to the base of the shape and it is inverted. As such, the conical cylinder has a tapered profile from one end to the other. In the shown embodiment, the profile of the elongated center portion 124 tapers from the first enlarged member 20 to the second enlarged member 22. The enlarged members 20 and 22 still have the differing dimensions to encourage a curved rolling path or curved trajectory 40 as previously described.

The angle at which the elongated central portion 124 tapers from the first end to the second end can vary depending on the application specific needs of the pet toy 110. For example, for a pet toy 110 that is intended to be used with smaller dogs, a greater taper angle may be desirable. Whereas larger dogs may prefer the pet toy 110 to have a smaller taper angle. In one embodiment, the elongated central portion 124 may taper approximately 25% over its longitudinal length. Stated otherwise, if the diameter of the elongated central portion 124 is equal to X near the first enlarged member 20, then the diameter of the elongated central portion 124 may equal approximately 75% of X near the second enlarged member near the second enlarged member 22. Thus, if the elongated central portion 124 has an exterior diameter that is a factor of 4 units near the first enlarged member 20, then the elongated central portion 124 would have an exterior diameter that is a factor of 3 units near the second enlarged member 22.

FIGS. 19-27 depict that pet toy 210 may include one or more apertures or holes 242 that extend entirely through body 12 at the elongated central portion 224. The elongated central portion 224 of pet toy 210 can be either a tapered cylindrical shape (e.g., similar to pet toy 110) or a straight cylinder (e.g., similar to pet toy 10).

The holes 242 extend radially relative to axis 18. The holes 242 may define a plurality of holes that are in open communication with the internal center cavity 26 of the elongated central portion 224. The holes 242 may extend in the spiral or helical pattern in the interstitial space 38 located between adjacent ridge flights 36. In the shown embodiment, the holes 242 are located in each space 38 between adjacent ridge flights 36, however it is possible for the holes 242 to be located in only some of the spaces 38 between adjacent ridge flights 36. Further, although the holes 242 follow the spiral pattern or helical pattern, this is not required. Further, the holes 242 may all have uniform diameters or some holes 242 may have different diameters than each other.

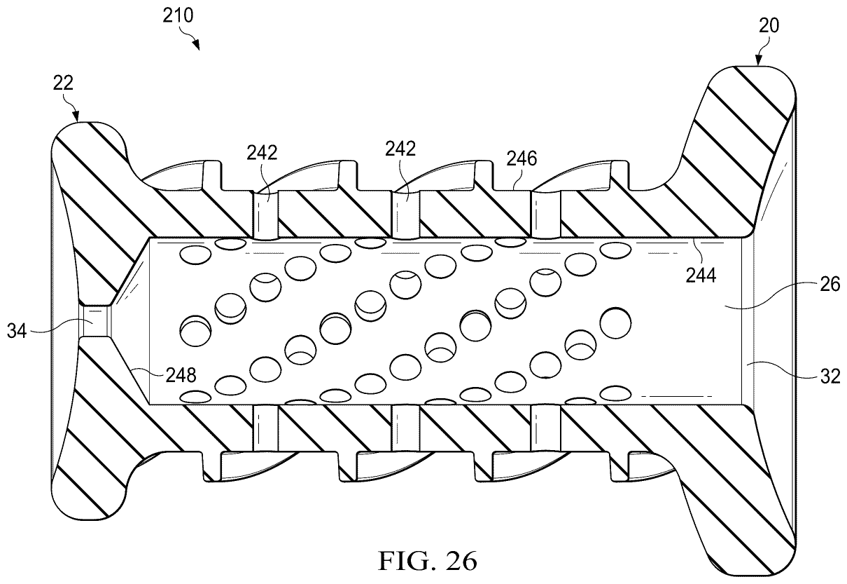

As shown in FIG. 26, the holes 242 extend entirely through the central portion 224 from the inner surface 244 to the outer surface 246 thereof. The inner surface 244 defines the center cavity 26. The inner surface 244 may have a substantially uniform diameter along the length of the cavity 26, regardless of whether the exterior surface of the central portion 224 is straight or tapered.

Near the second end of the cavity 26, the inner surface 244 may include a tapered wall 248. The tapered wall terminates at an edge defining the circular opening 34 in the second enlarged member 22. The tapered wall tapers at an angle that complements an end a plunger, discussed infra.

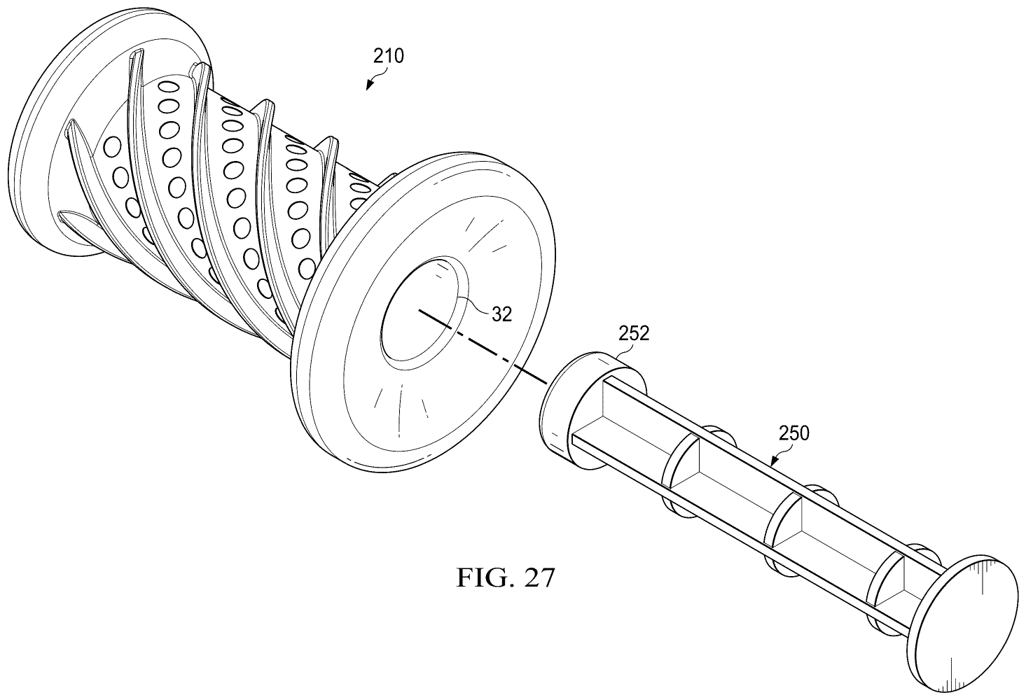

With continued reference to FIG. 26 and FIG. 27, the internal center cavity 26 is configured to receive a pet treat therein. The pet toy 210 (or the other embodiments of the pet toy) can be used in conjunction with a syringe-style plunger 250. The plunger has a distal end 252 that is shaped with a tapered surface that complements or matches the angle or orientation of the tapered wall 248 in the elongated central portion 224. Further, the diameter of the distal end 252 of the plunger complements or matches the inner diameter of the inner surface 244 of the elongated central portion 224.

In one embodiment, the distal end 252 of the plunger 250 is where the plunger interfaces with a material (e.g., pet treat or medication) inside of bore or cavity, such as cavity 26. The distal end 252 of the plunger 250 typically has a generally conical shape. This conical surface serves several purposes. When the plunger 250 is pushed into the bore or cavity 26, the conical tip of distal end 252 creates a tight seal against the inner walls or inner surface 244 that defines cavity 26. As the plunger 250 is pushed, the conical surface of distal end 252 helps move the material through the cavity 26. The conical shape also minimizes the dead space to ensure that the maximum amount of material can be expelled or ejected from the pet toy.

In operation, a user will load a pet treat into the center cavity 26 of the pet toy. This occurs by inserting the pet treat through the opening 32 formed in first enlarged member 20. In one exemplary embodiment, the pet treat may be in the form of a paste or paste-like treat material that is contained or sold in a flexible tube. The end of the flexible tube can be cut or otherwise torn to create an opening in the flexible tube storing the treat material. The opened flexible tube is then inserted into the cavity 26. Then, the tube is squeezed to dispense the paste or paste-like treat material into the cavity 26. Alternatively, a user may apply a pinching force between the flexible tube and the sidewall or edge defining opening 32. Then, with the tube pinched against the edge, pulling the flexible tube out of the cavity 26. The pinched tube will cause the paste or paste-like treat material to exit the open end of the flexible tube in response to pulling the flexible tube through the pinched region, and thereby dispose the treat material in the cavity 26.

After loading the paste or paste-like treat material into the inner cavity 26, then a user can align the length of the plunger 250 axially along the axis 18, as shown in FIG. 27. In this orientation, the distal end 252 of the plunger 250 is closer to the pet toy 210 than the proximal end of the plunger 250. As such, the plunger is moved closer to the first end of the pet toy 210. The plunger 250 continues to move toward the pet toy 210 until the distal end is inserted through the opening 32 in the first enlarged member 20. The diameter of the distal end 252 may also match, equal or complement the diameter of the of the opening 32. This allows the plunger to be inserted through opening 32. A user continues to apply force to the proximal end of the plunger 250 along axis 18.

With the distal end 252 of plunger 250 now in the central cavity 26, a user will continue to apply force along axis 18 to push the plunger 18 further into the cavity 26. Recall, the pet treat will have already been inserted into the central cavity 26 before the plunger 250 is inserted into the cavity. Thus, as the user pushes the plunger 250 deeper into the cavity 26, the pet treat will be expelled through, ejected from, or dispensed from holes 242. This expulsion or dispensation of the treat will dispose the treat on the exterior surface 246 of the elongated central portion 224. The pet can then lick or eat the treat that has been disposed on the exterior surface 246 of the elongated central portion 224.

Due to the use of the plunger to dispense the treat, it is preferable that the treat be a semi-solid or viscous material to effectuate the dispensation, rather than a hard, solid or non-viscous material. In one particular embodiment, an exemplary treat that is used with the pet toys of the present disclosure and plunger 250 is peanut butter. Peanut butter is suitable as it is a non-Newtonian fluid that exhibits shear-thinning behavior. However, other more viscous Newtonian or non-Newtonian fluids (e.g., gels) are entirely possible. For example, this assembly can be used with yogurt, cottage cheese, custard, oatmeal, or other more viscous foodstuffs that are unharmful and/or beneficial to pets. These are all examples of paste or paste-like treat material. This paste or paste-like treat material could also be used to dispense medicine to the pet when the medicine is integrated into the treat. For example, medicine for a dog can be impregnated into the treat such that the dog consumes the medicine in response to licking or eating the treat. Additionally, supplements can be incorporated into the pet treat. For example, a variety of pet supplements can be incorporated into the paste or paste-like treat material for dispensing from the inner cavity, such as Glucosamine, Coenzyme Q10 (CoQ10), Omega-3 Fatty Acid, Multivitamins, Probiotics, Calcium, or the like.

In one particular example, when the treat is a paste or paste-like material, such as peanut butter or yogurt, as the plunger moves axially along axis 18, it creates shear forces within the peanut butter. These shear forces cause the paste material (e.g., peanut butter) to behave like a non-Newtonian fluid—its viscosity changes under stress. The increased pressure from the plunger 250 forces the paste or paste-like treat material to flow. Due to the radial holes 242, the paste or paste-like treat material starts moving outward from the central bore or cavity 26. The holes 242 act as channels, allowing the paste or paste-like treat material to escape. As the plunger 250 continues to push, the paste or paste-like treat material flows through these holes 242. In one exemplary embodiment, when the shear forces increase (due to plunger 250 movement along axis 18), the paste or paste-like treat material becomes less viscous. This allows the paste or paste-like treat material to flow more easily through the holes 242. The paste or paste-like treat material's consistency changes from stiff to less stiff as it is pushed out of the holes 242. This combination of the pet toy, the plunger 250 and the paste or paste-like treat material may be used for dispensing paste or paste-like treat material in a controlled manner. By adjusting the plunger force along axis 18, the user (i.e., pet owner) can control the rate of paste or paste-like treat material flow through the holes 242.

To estimate the force required to expel the paste or paste-like treat material from the pet toy, a manufacturer of the pet toy should consider the shear stress needed to push paste or paste-like treat material through the holes 242. Shear stress depends on factors like hole 242 diameter, paste or paste-like treat material viscosity, and pressure. The amount of force that a user should apply to plunger 250 will depend on hole 242 diameter (e.g., smaller holes require more force due to increased shear stress), paste or paste-like treat material consistency (e.g., runnier paste or paste-like treat material flows more easily), and plunger design (e.g., the shape, diameter and/or and surface area of the distal end of the plunger).

It has been determined that some beneficial configurations of the pet toy can account for the diameter of the holes 242 relative to the inner diameter of the center cavity (i.e., measured between two points on the inner surface orthogonal to axis 18). In one exemplary embodiment, the holes 242 may have a diameter that is in a range from about 3 millimeters to about 9 millimeters. In one particular embodiment, the holes 242 have a diameter that is about 5 millimeters.

In one exemplary embodiment, the inner diameter of cavity 26 measured across the inner surface 244 may be in a range from about 22 millimeters to about 32 millimeters. In one particular embodiment, the inner diameter of cavity 26 is about 27 millimeters (about 1 inch). However, this diameter be smaller when the pet toy is marketed for smaller pets, such as cats. For example, for smaller animals/pets, the inner diameter of cavity 26 measured across the inner surface 244 may be in a range from about 7 millimeters to about 15 millimeters.

The ratio of the inner diameter of cavity 26 to the diameter of the holes (e.g., holes 242 or other holes shown herein) may be in a range from about 3:1 to about 7:1. In one particular embodiment, the ratio of the inner diameter of cavity 26 to the diameter of the holes (e.g., holes 242 or other holes shown herein) is about 5:1 (e.g., about 27:5). It has been found that these ratios are beneficial to balance the amount of force required to expel the paste or paste-like treat material from the bet treat without sacrificing functional sealing that the holes provide when the plunger is not inserted in the pet toy such that the paste or paste-like treat material does not inadvertently leak.

The dimension of the distal end 252 of the plunger 250 that matches the center cavity 26 is beneficial to clean the inner surface 244 as the treat is dispensed. Much like a plunger would effectively clean the cylinder of a syringe as medicine is dispensed, the distal end 252 of the plunger 250 moves along the inner surface in a tight sliding frictional engagement to effectively scrape the inner surface 244 to leave a clean surface after the distal end 252 of the plunger has passed.

This distal end 252 of the plunger 250 continues to be pressed toward the second end of the pet toy 210 toward the second enlarged member 22 until the tapered wall on the distal end 252 meets the tapered wall 248 on the inner surface 244. As the tapered wall on the distal end 252 meets the tapered wall 248 on the inner surface 244 and remaining treat is expelled or dispensed from the opening 34 in the second enlarged member 22.

FIGS. 28-30 depict that pet toy 310 may include one or more apertures or holes 342 that extend entirely through body 12 at the elongated central portion 324. The elongated central portion 324 of pet toy 310 can be either a tapered cylindrical shape (e.g., similar to pet toy 110) or a straight cylinder (e.g., similar to pet toy 10).

The holes 342 extend radially relative to axis 18. The holes 342 may define one or more holes that are in open communication with the internal center cavity 26 of the elongated central portion 324. This embodiment differs in that the ridges 336 extend in a linear manner (i.e., non-helical) between the first enlarged member 20 and the second enlarged member 22. The interstitial space 338 is also linearly elongated.

The holes 342 may extend in the linear pattern in the interstitial space 338 located between adjacent ridges 336. In the shown embodiment, the holes 342 are located in only some of the spaces 338 between adjacent ridges 336. In this particular embodiment, the purpose of only forming holes 342 is some of the spaces 338 is for ease of manufacture. Namely, if pet toy 310 is molded product, then forming the molds with many holes 342 can be difficult or costly to produce. Therefore, pet toy 310 provides a suitable alternative in which the holes 342 are suitable for ejecting the pet treat form the center cavity in the manner previously described with the plunger 250 but also reduces manufacturing costs.

Particularly, the shown example of pet toy 310 depicts holes 342 on only two sides of the elongated central portion 324. This is beneficial when the pet toy 310 is molded from two molds that join at a parting line. It is possible for the holes 342 on each side of the pet toy 310 to all have the same diameter or to have different diameter. The particular configuration shown in FIGS. 28-30 depicts a first set of holes 342A formed on a first side of the elongated central portion 324 that have a larger diameter than a second set of holes 342B on a second side of the elongated central portion 324. In some exemplary embodiments, the set of holes 342A may have a diameter that is in a range from about 3 millimeters to about 9 millimeters. In one particular embodiment, the set of holes 342A have a diameter that is about 5 millimeters. In some exemplary embodiments, the set of holes 342B may have a diameter that is in a range from about 1 millimeter to about 4 millimeters. In one particular embodiment, the set of holes 342B have a diameter that is about 2 millimeters. In another particular embodiment, a ratio of the diameter of the set of holes 342A to the diameter of set of holes 342B is 5:2. These holes may also be smaller that these exemplary dimensions if the pet toy is marketed for smaller pets such as cats or small dogs.

FIGS. 31-38 depict that pet toy 410 includes a body 412. The body 412 may be generally shaped as a dumbbell or barbell having enlarged ends and an elongated center portion extending between the enlarged ends. Although this particular embodiment is generally dumbbell-shaped or barbell-shaped, other shapes are entirely possible as described herein.

The body 412 of the pet toy 410 may be composed of a body first portion 412A and a body second portion 412B. The body second portion 412B may be over-molded onto the body first portion 412A.

The body first portion 412A may be formed as a unibody that is integrally extruded, molded, printed, or additively manufactured, removably machined, or formed as a unitary, monolithic member substantially fabricated from a flexible, semi-flexible or semi-rigid, manmade or natural, material. The body first portion 412A of the pet toy 410 may be formed from a generally rigid material configured to withstand deformation upon chewing or bending by the pet (i.e., a dog). In one example, polymers, such as silicone, plastic (polypropylene or PVC), rubber, or nylon may form a substantial majority of the components or elements used to fabricate the first body portion 412A of the pet toy 410 and the various components integrally formed, molded, or extruded therewith. Silicone is a polymerized siloxane compound, consisting of chains made of alternating silicon (Si) and oxygen (O) atoms. While most industrial polymers contain carbon in their backbones, silicones are unique “inorganic” polymers. Silicones are known for their chemical inertness, resistance to water and oxidation, stability at extreme temperatures, flexibility, and heat resistance. Plastics are polymeric materials with diverse properties. They can be molded or shaped due to their plasticity, which combines low density, low electrical conductivity, transparency, and toughness. Some exemplary commodity resins include high-volume, low-cost plastics such as polyethylene, polypropylene, polyvinyl chloride (PVC), and polystyrene. Natural rubber, also known as latex, consists of polymers of the organic compound isoprene (C₅H₈). It contains minor impurities of other organic compounds. Natural rubber is stretchable, resilient, and waterproof. The pet toy body should withstand typical bite forces or chewing forces imparted from a dog that interacts with the pet toy with the dog's mouth.

In another particular embodiment, the body first portion 412A of the pet toy 410, when crafted from nylon, exhibits specific properties that make it suitable for pet interaction. Nylon is a synthetic polymer known for its strength, durability, and flexibility. It belongs to the family of polyamides and is commonly used in various applications due to its favorable properties. Nylon consists of repeating units linked by amide bonds. It contains carbon (C), hydrogen (H), oxygen (O), and nitrogen (N) atoms in its backbone. Unlike natural rubber, nylon is an inorganic polymer, meaning it lacks carbon-carbon (C—C) bonds in its backbone. Instead, it contains amide (C—N) linkages. Nylon is robust and can withstand mechanical stress, including biting forces from pets. Yet, it remains flexible even under strain, making it suitable for pet toys. Nylon can be modified to have a textured surface for better grip during play. Nylon can be dyed in various colors to enhance visual appeal.

The body second portion 412B may be integrally connected to the body first portion 412A via an over-mold technique or process. The body second portion 412B is softer or has a lower hardness value than the body first portion 412A. For example, the when the body first portion 412A is made from a more rigid nylon material, the body second portion may be made from a softer rubber or silicone material. Collectively, when the body second portion 412B is over-molded onto the body first portion 412A they define the body 412. The two varying or differing materials cooperate to collectively provide structural rigidity for the pet toy 410 while simultaneously having softer portions that are more gentle on the teeth of the pet during use.

While the components of the body 412 of the pet toy 410 are discussed below individually, it is to be clearly understood that the components and their corresponding reference elements of the pet toy body are portions, regions, or surfaces of the body 412 and all form a respective element or component of the unitary pet toy body. Thus, while the components may be discussed individually and identified relative to other elements or components of the body 412 of the pet toy 410, in this exemplary embodiment, there is a single pet toy body 412 having the below described components, parts, portions, regions, or surfaces.

The body 412 of the pet toy 410 extends between a first end 414 and a second end 416 along the center longitudinal axis 18. A first enlarged member 420 defines the first end 414 of the body 412. A second enlarged 422 member defines the second end 416 of the body 412. The elongated central portion 424 of the body 412 extends between the first enlarged member 420 and the second enlarged member 422. The elongated central portion 424 has an inner surface 444 that defines a majority of cavity 426. The elongated central portion 424 has a narrower diameter than the enlarged members 420 and 422.

There is at least one opening or hole defined in the body. The at least one opening is in open communication with the cavity, and the opening permits a treat stored in the cavity to exit the body 412. In this embodiment, the opening that permits the expulsion of the treat is formed in the second enlarged member 422. More particularly, and as will be described in greater detail below, this embodiment provides a plurality of openings 434 formed in the second enlarged member 422 that are in open communication with the interior cavity 426 to enable the plunger 450 is dispense or expel the pet treat through the openings 434.

There is a first dimension 428 of the first enlarged member 420. The first dimension 428 extends through the center longitudinal axis 18 and is measured between two different points on a perimeter of the first enlarged member 420. In one embodiment, the first dimension 428 is a diameter when the first enlarged member 420 has a circular profile. However, the dimension 428 may not be a “diameter” should the first enlarged member 420 have a profile shape that is different from a circular profile.

There is a second dimension 430 of the second enlarged member 422. The second dimension 430 extends through the center longitudinal axis 18 and is measured between two different points on a perimeter of the second enlarged member 422. In one embodiment, the second dimension 430 is a diameter when the second enlarged member 22 has a circular profile. However, the dimension may not be a “diameter” should the second enlarged member 22 have a profile shape that is different from a circular profile.

In one particular embodiment, the first dimension 428 is greater than the second dimension 430. The advantage of having the first dimension 428 being different or greater than the second dimension 30 is that it causes the pet toy 410 to roll in a circle (e.g., along a curved trajectory) when the pet toy rotates about the longitudinal axis 18. This causes the pet toy 410 to remain within a general area bound by the rolling path. This is beneficial for pet owners so that the pet toy 410 does not roll away during use/play into another area of the home that the pet owner does not want the pet to take the toy. For example, the pet toy 410 will roll in a circle on a tile floor and will not inadvertently roll away onto a carpeted area.

More specifically, when the two enlarged members 420 and 422 that have differing diameters are connected by the elongated central portion 424, which acts as an axle, the pet toy 410 will exhibit unique rolling behavior. Namely, as one of the enlarged member rolls, a point on its perimeter traces out a specific path. This path is called a cycloid. Due to the different diameters, the two enlarged members exhibit different cycloid curves. The different cycloid curves cause the pet toy to roll along a curved trajectory in a circular motion (when viewed from above). Particularly, when the pet toy 410 rolls, the larger enlarged member (i.e., the first enlarged member 420) travels a longer distance (circumference) in one revolution compared to the smaller enlarged member (i.e., the second enlarged member 422). Since the first and second enlarged members 420 and 422 are connected by the elongated central portion 424, they all rotate together. However, due to their differing diameters or circumferences, the enlarged members 420 and 422 experience different angular displacements during each rotation. The larger enlarged member (i.e., the first enlarged member 420) covers a larger angle (i.e., more radians) than the smaller enlarged member (i.e., the second enlarged member 422). This difference in relative motion causes the pet toy 410 to veer off its straight path when rolling and rotating about the axis 18. The combined effect of the differing angular displacements results in a curved trajectory for the pet toy 410 as it rolls. The pet toy 410 tends to turn toward the side with the smaller enlarged member (i.e., the second enlarged member 422).

The different sizes of the first enlarged member 420 and the second enlarged member may establish a ratio of the first dimension 428 to the second dimension 430. In one embodiment, the ratio of the first dimension 428 to the second dimension 430 is at least 1.05:1. In another embodiment, the ratio of the first dimension to the second dimension, is in a range from about 1.05:1 to about 4:1. These dimensions and ratios are not mere matters of design choice. Rather, it has been determined that the embodiments that utilize this ratio can optimize the rolling of the pet toy 410 along a curved path or trajectory that permits a sufficient amount of rolling to stimulate the dog but still sufficiently maintain or keep the pet toy 410 in a desired area during usage by the pet. In one specific embodiment, the ratio of the first dimension 428 to the second dimension 30 is 4:3.25. When the ratio is 4:3.25, the first dimension 428 is four units (i.e., inches) and the second dimension is 3.25 units (i.e., inches). These units show that one particular embodiment has a ratio of the first dimension 428 to the second dimension 430 that is about 4:3.25 (i.e., 16:13 or about 1.23:1).

In the shown exemplary embodiment, the first and second enlarged members 420 and 422 are disc-like enlarged regions that have an exterior surface. Each of the first and second enlarged members 420 and 422 also have outermost edges, and outermost surfaces. The first enlarged member 420 may define an opening 432 that is in open communication with the cavity 426 of the elongated central portion 24. This exemplary opening 432 is free of any lobes or other obstructions and is simply generally circular in shape.

The second enlarged member 422 may also define the plurality of openings 434 that are in open communication with the internal cavity 426. An edge defining each of the openings 434 may have any geometric shape. The opening 434 formed in the second enlarged member 422 extend fully from the outer surface to the inner surface 448 or the second enlarged member 422. Each of the openings 434 that extends through the second enlarged member 422 may be counterbored or define a counterbore such that the dimension of the opening 434 is greater near the outer surface than the inner surface. Stated otherwise, each opening 434 may include an inner portion 460 and an outer portion 462. The outer portion 462 of each of the openings 434 has a greater dimension measured orthogonal to the longitudinal axis 18 than a smaller dimension of the inner portion 460 that is measured orthogonal to the longitudinal axis 18. Each counterbore defined by the outer portion 462 has an individual volume notwithstanding its open communication with the inner portion 460. The outer portion 462 defines a recess or cavity via the counterbore that is configured to retain the pet treat. Preferably, the pet treat has a thick enough viscosity that the pet treat will be frictionally engaged and retained in the counterbore or cavity such that the pet treat does not spill further outward beyond the bounds of the second end 416. This should provide the pet owner with confidence that the pet treat will not spill onto the floor when the pet treat is expelled from the cavity 426 into the outer portion 462 of the opening 434. Stated otherwise, the purpose for the outer portions 462 defining a counterbore having a greater dimension than the inner portion 460 is that each of the outer portions 462 creates a cavity or well that is configured to receive and contain the pet treat therein when the pet treat is expelled from the inner cavity 426 outward through the inner portions 460 of the openings 434. The wells or cavities defined by the outer portions 462 of the openings 434 retains the pet paste and enables the pet, such as a dog, to lick the second end 416 of the pet toy 410 to receive the treat. However, the retention of the treat within the cavities or wells defined by the outer portion 462 also prevents the treat from spilling out of the pet toy 410 and dropping onto a surface upon which the pet toy 410 is supported, such as the floor of the pet owner's home.

The inner surface 448 of the second enlarged member 422 complements an end (e.g., distal end 452, discussed below) of the plunger 450 that is inserted axially along the center longitudinal axis 18 through the cavity 426. In one embodiment, both the inner surface 448 and the distal end 452 of plunger 450 are oriented orthogonal to and intersect with axis 18. In other embodiments, it is possible for the angular intersection of the inner surface 448 and the distal end 452 of plunger 450 to be non-orthogonal relative axis 18.

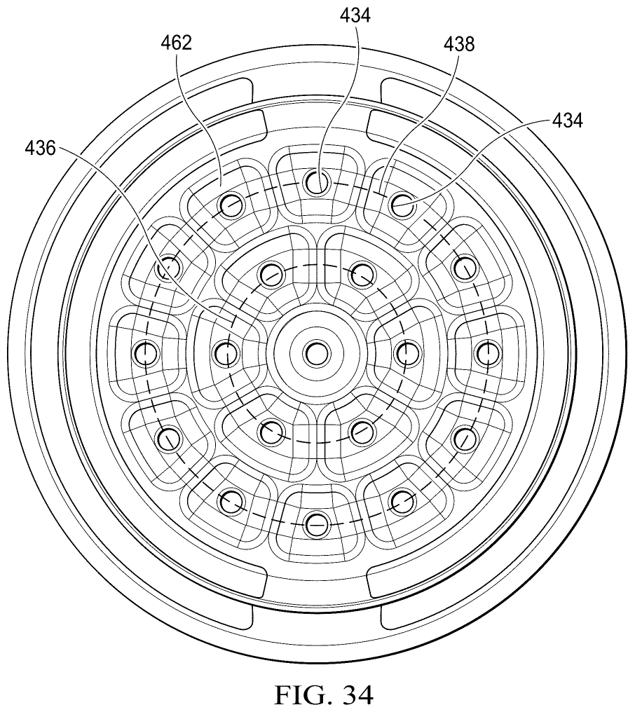

As shown in FIG. 31 and FIG. 34, the plurality of openings 434 may form concentric patterns or a concentric arrangement relative to a central opening 434A that extends coaxially along longitudinal axis 18. The central opening 434A may have an outer portion 462 that is defined by a circular cylindrical wall, however other shapes are entirely possible. A first concentric ring 436 of distinct openings 434 may surround the central opening 434A. In the shown embodiment, there are six openings 434 in the first concentric ring 436 that surrounds the central opening 434A, however other amounts are entirely possible. The outer portion 462 of these openings may be formed by generally trapezoidal shaped outer portions 462. There may also be a second concentric ring 438 of openings 434 also formed of generally trapezoidal outer portions 462 that are radially farther away from the longitudinal axis 16. In the shown embodiment, there are twelve openings 434 in the second concentric ring 438 that surrounds the central opening 434A, however other amounts are entirely possible.

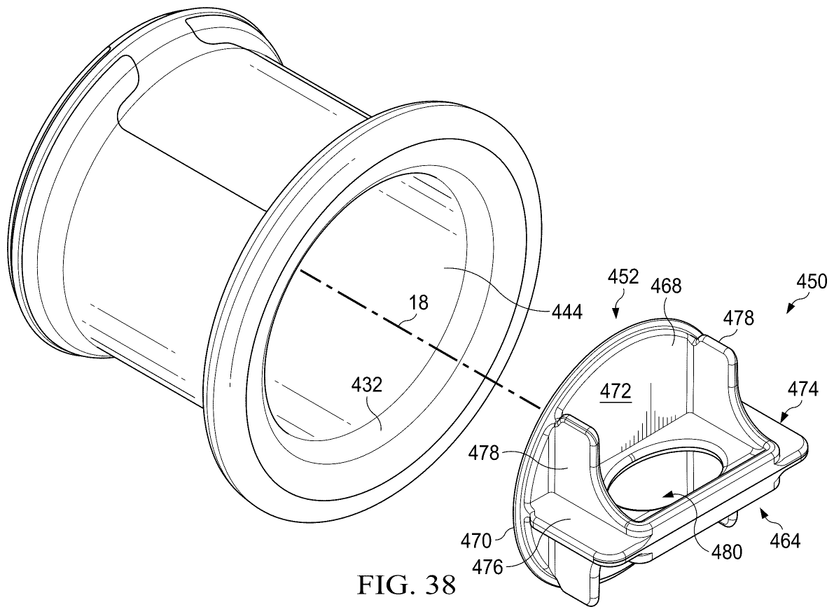

FIG. 38 depicts the plunger 450 having a distal end 452 and a proximal end 464. The distal end 452 is defined by a generally round or circular plate 468. Circular plate 468 includes a flat distal end surface 470 that has a diameter that approximates the internal diameter of the elongated central portion 424. Opposite the flat end surface 470 of the circular plate 468 is a rear surface 472. A handle 474 extends proximally outward and away from the rear surface 472. The handle 474 defines the proximal end 464 of the plunger 450. The handle 474 may be defined by two opposing brace walls 478 that act as supports or braces for a transverse wall 476. The transverse wall 476 defines a central opening 480 through which a user can insert their finger as the plunger 450 is being pushed axially along longitudinal axis 18 after the pet treat has been loaded into the cavity 426. The opening 480 may be generally elliptical in shape and formed with rounded edges for comfort of the user. The brace walls 478 may take any form or configuration that support and brace the transverse wall 476 during its forceful movement through the cavity 426. Thus, although the brace walls 478 are generally shown as L-shaped walls on each respective side of the opening 480 in the transverse wall 476, other configurations of the brace walls 478 are entirely possible. Additionally, the brace walls 478 may be mirrored on both the top surface and the bottom surface of the transverse wall 476.

In operation, a user will load a pet treat into the center cavity 426 of the pet toy 410. This occurs by inserting the pet treat through the opening 432 formed in first enlarged member 420. In one exemplary embodiment, the pet treat may be in the form of a paste or paste-like (e.g., gel) treat material that is contained or sold in a flexible tube. The end of the flexible tube can be cut or otherwise torn to create an opening in the flexible tube storing the treat material. The opened flexible tube is then inserted into the cavity 426. Then, the tube is squeezed to dispense the paste or paste-like treat material into the cavity 426. Alternatively, a user may apply a pinching force between the flexible tube and the sidewall or edge defining opening 432. Then, with the tube pinched against the edge, pulling the flexible tube out of the cavity 426. The pinched tube will cause the paste or paste-like treat material to exit the open end of the flexible tube in response to pulling the flexible tube through the pinched region, and thereby dispose the treat material in the cavity 426.

After loading the paste or paste-like treat material into the inner cavity 426, then a user can align the length of the plunger 450 axially along the axis 18, as shown in FIG. 38. In this orientation, the distal end 452 of the plunger 450 is closer to the pet toy 410 than the proximal end 464 of the plunger 450. As such, the plunger 450 is moved closer to the first end of the pet toy 410. The plunger 450 continues to move toward the pet toy 410 until the distal end 452 is inserted through the opening 432 in the first enlarged member 420. The diameter of the distal end 452 may also substantially match, equal or complement the diameter of the opening 432. This allows the plunger to be inserted through opening 432. A user continues to apply force to the proximal end of the plunger 450 along axis 18. The cavity 426 has a total length that measured parallel to the axis 18.

With the distal end 452 of plunger 450 in the central cavity 426, a user will continue to apply force along axis 18 to push the plunger 450 further into the cavity 426. In one example, the plunger is pushed a first distance into the cavity 426, wherein the first distance is less than the total length of the cavity. Recall, the pet treat will have already been inserted into the central cavity 426 before the plunger 450 is inserted into the cavity 426. Thus, as the user pushes the plunger 450 deeper into the cavity 426, the pet treat will be expelled through, ejected from, or dispensed from openings 432. This expulsion or dispensation of the treat will dispose or position the treat on the exterior surface of the second enlarged member 422 through openings 432. The pet can then lick or eat the treat that has been disposed on the exterior surface of the second enlarged member 422.

In another example operation of pet toy 410, the pet treat is loaded into internal cavity 426 by the pet owner. More particularly, the pet owner will insert the pet treat through the opening 432 and into the cavity. One advantage of the pet toy 410 over other embodiments is that the internal volume of the cavity 426 is larger than the cumulative volume of the counterbores defined by the outer portions of the openings 434. This allows a greater volume of the pet treat to be inserted into the cavity so that the pet owner can more fully load the cavity 426 with the pet treat and utilize the pet treat over multiple rounds of engagement with the pet. For example, the pet treat may be loaded into the cavity in a manner that substantially fills the cavity 426 until it is substantially near the opening 432. Thereafter, the pet owner may grasp the plunger 450, typically by inserting a finger through the opening 480 in the handle 474. The distal end 454 of the plunger 450 may be moved the first distance toward the first end 414 axially along longitudinal axis 18 to pass through the opening 432. Inasmuch as the circular plate 468 that defines the distal end 452 of the plunger 450 has the same or a complementary diameter as the internal diameter of the cavity 426, a frictional interference fit is established between the outer perimeter or outer circumference of circular plate 468 as it moves through the opening 432 and into contact with the inner surface 444 or the elongated central portion 424.

The user may then push or actuate the handle 474 on the plunger 450 axially along axis 18 to move some portion of the pet treat outward through the openings 434 in the second end 422. Namely, the pet treat will first be expelled through the inner portion 460 and then be expelled into and retained by the outer portion 462 and retained therein inasmuch as the outer portion 462 defines the slight cavity to retain the pet treat. In one particular embodiment, once the pet treat has been retained in the cavity defined by the outer portion 462 of the opening 434, the user will stop forcing the pet treat outward. Because the volume of the plurality of the cavities defined by the outer portions 464 of the plurality of openings 434 is cumulatively less than the volume of the interior cavity 426, the user will be able to have multiple “rounds” or multiple “charges” of treat expulsions. For example, once a first round or portion of the pet treat is within the cavities defined by the outer portions 462, a significant majority of the pet treat is still retained within the cavity 462. After the pet consumes the treat that is retained in the cavities defined by the outer portion 462, the pet owner may then push the plunger 450 farther toward the second end 416 or the second enlarged member 422 by a second distance that is less than the total length of the cavity 426 to expel an additional or second amount of pet treat into the cavities defined by the outer portion 462 of the openings 434. This process may continue a third time by pushing the plunger 450 a third distance that is less than the total length of the cavity 426 after the pet has consumed the pet treat after the second expulsion or discharge.

Another manner of describing this process is that the pet toy 410 comprises a central cavity 426 configured to receive a paste-like treat material, such as peanut butter or a similar edible substance. The cavity 426 functions as a dosing reservoir, capable of retaining a volume of treat that exceeds the amount typically dispensed in a single use. The plunger 450 is operatively moved into the cavity 426 and is configured to expel discrete doses of the treat through one or more openings 434 formed in the body 412 of the toy. Upon actuation of the plunger 450, a controlled quantity of the treat is dispensed externally, allowing the pet to access and consume the dose. The user may repeat this dispensing process multiple times without refilling the cavity 426, thereby enabling sequential dosing events from a single loading operation. This configuration facilitates efficient treat management, reduces mess, and enhances user control over treat delivery during pet interaction.

Yet another manner of describing this process is that the plunger 450 is used to incrementally dispense the treat through one or more holes 434 formed in the outer surface of the pet toy 410. Each actuation of the plunger 410 results in a metered dispensing event, wherein a controlled portion of the treat is extruded or dispensed from the cavity 426 and made accessible to the pet. This incremental dispensing functionality enables the user to deliver successive portions of the treat without the need to reload or refill the cavity after each use, thereby enhancing convenience and reducing waste. The metered output also allows for tailored treat delivery based on pet engagement or behavioral reinforcement protocols. It is possible for the elongated central portion to have a metered viewing window so that the user can view how much treat material is dispensed.

Yet another manner of describing this process is that a reservoir is defined by the internal cavity 426 formed within the body 412 of the toy 410 and is dimensioned to retain a volume of treat sufficient for multiple dispensing operations. A portioning mechanism, such as the manually actuated plunger 450, is operatively coupled to the reservoir and configured to expel discrete portions of the treat through one or more openings 434 formed in the toy's exterior surface. Upon each actuation, a controlled quantity of the treat is delivered externally, allowing the pet to access and consume the portion. This reservoir and portioning configuration enables repeated dispensing events from a single loading operation, thereby reducing the need for frequent refilling and enhancing user convenience during interactive pet engagement.

It is envisioned that the cumulative volume of the outer portions 462 of the plurality of openings 434 is approximately one-third or less that of the volume of the cavity 426. Stated otherwise, because the cumulative volume of the outer portions 462 of the plurality of openings 434 is about one-third or less than that of the interior cavity 426, the pet owner should be able to achieve at least three “rounds” or “charges” of usage when the pet treat first fills the interior cavity 426. This is advantageous inasmuch as it reduces the number of times that the pet owner must reload, recharge or refill the interior cavity 426 of the pet toy 410 with the pet treat. In another other embodiment, the cumulative volume of the outer portions 462 of the plurality of openings 434 is approximately one-fourth, one-fifth, one-sixth, one-seventh, one-eighth, one-ninth, one-tenth or less that of the volume of the cavity 426, which would enable pet owner should be able to achieve at least four, five, six, seven, eight, nine, or ten or more “rounds” or “charges” of usage, respectively, when the pet treat first fills the interior cavity 426.

The length of the plunger 450 measured between the distal end 452 and the proximal end 454 should be shorter or less than the length of the cavity 426 measured along the axis 18 between wall 448 and the opening 432. The advantage of making the length of the plunger shorter than the length of the cavity 426 is that it reduces the likelihood, discourages, or inhibits the pet from being able to pull or chew on the plunger 450, such as the handle 474, while the plunger 450 is disposed or positioned within the cavity 450. In one embodiment, the length of the plunger 450 is about ⅗ (about 60%) or less than the length of the cavity 450. For example, if the length of cavity 450 is about 2.5 inches, then the length of the plunger 450 is about 1.5 inches or less (e.g., 1.5 or less/2.5=0.6 or less).

This technique of dispensing a treat from a pet toy does not need to be used with the barbell shaped toys previously discussed. The plunger 250 or 450 can be utilized to dispense a treat from a pet toy, regardless of its exterior configuration. For example, the pet toy could have the exterior shape of an inanimate object, such as a fire hydrant, a dog bone, a ball, or any other shape that is appealing and/or stimulating to a dog. Alternatively, the pet toy could have an exterior shape that is symbolic of an organism from any taxonomic domain or kingdom. For example, the pet toy can generally resemble a fish, an animal, or a reptile. Each of these exemplary pet toys can have openings 34 or 434 formed through the sidewall of the body, particularly at the elongated central portion defining a central cavity similar to cavity, which is configured to eject or dispense a pet treat when pushed/expelled with plunger 250 or 450.

Additionally, although reference has been made to actuation of the plunger in a direction that is parallel to the longitudinal axis 18, it is possible for the plunger 450 to move into or through the cavity 426 in a direction that is not parallel to the axis 18.

Unless explicitly stated that a particular shape or configuration of a component is mandatory, any of the elements, components, or structures discussed herein may take the form of any shape. Thus, although the figures depict the various elements, components, or structures of the present disclosure according to one or more exemplary embodiments, it is to be understood that any other geometric configuration of that element, component, or structure is entirely possible. For example, instead of the holes 242 or 342 being circular, the holes 242 or 342 can be semi-circular, triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any letter shape (i.e., A-shaped, B-shaped, C-shaped, D-shaped, E-shaped, F-shaped, G-shaped, H-shaped, I-shaped, J-shaped, K-shaped, L-shaped, M-shaped, N-shaped, O-shaped, P-shaped, Q-shaped, R-shaped, S-shaped, T-shaped, U-shaped, V-shaped, W-shaped, X-shaped, Y-shaped, or Z-shaped), or any other type of regular or irregular, symmetrical or asymmetrical configuration. In another example, instead of the outer portions 462 that define the counterbore being circular or trapezoidal, any of these other shapes are possible and available as part of the inventive matter without departing from the scope of the present disclosure.

In another example, instead of the one or more holes 242 or 342 being circular, there may be only a single hole in one of the interstitial spaces that is shaped as a thin slit defined by an elongated rectangle or similar shape.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. As another example, “at least one of: A, B, or B” is intended to cover A, B, C, A-B, A-C, B-C, and A-B-C, as well as any combination with multiple of the same item.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performs the event or had the event occur to the second party. Stated otherwise, effecting refers to one party giving or providing another party the tools, objects/items, or resources (i.e., directions, instructions, directives, orders, commands, advice, guidelines, tips, rules, or a manual etc.) to cause an event to occur. Thus, in this example a claim element of “effecting an event to occur” would mean that a first party is giving or providing a second party the tools, objects, or resources (i.e., directions, instructions, directives, orders, commands, advice, guidelines, tips, rules, or a manual, etc.) needed for the second party to perform the event, however the affirmative single action is the responsibility of the first party to provide the tools, objects/items, or resources (i.e., directions, instructions, directives, orders, commands, advice, guidelines, tips, rules, or a manual, etc.) to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments. Furthermore, the use of any and all examples or exemplary language (“e.g.,” “such as,” or the like) is intended merely to better illustrate or illuminate the embodiments and does not pose a limitation on the scope of that or those embodiments. No language in this specification should be construed as indicating any unclaimed element as essential to the practice of the disclosed embodiment.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element or “another” element, that does not preclude there being more than one of the additional element or the another element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein. Further, recitation of ranges of values herein are not intended to be limiting, referring instead individually to any and all values falling within that range, unless otherwise indicated herein, and each separate value within such range is incorporated into the specification as if it were individually recited herein.

As used herein, terms of approximation or degree such as “generally,” “substantially,” “approximately,” “about,” and the like are intended to account for variations that do not materially affect the intended function or result. Such terms are understood to include minor deviations from the literal expression that would be recognized by a person of ordinary skill in the art, including but not limited to variations arising from manufacturing tolerances, material inconsistencies, or environmental conditions. For example, a “generally cylindrical” shape encompasses structures that approximate a cylinder but may include slight tapering, surface irregularities, or other deviations that do not detract from the functional characteristics associated with a cylindrical form. Similarly, “substantially parallel” or “substantially equal” should be construed to include minor angular or dimensional differences that would be considered functionally equivalent in the relevant context. Unless otherwise indicated, such terms are not intended to limit the scope of the invention to absolute or idealized geometries or values.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, or in the context of those sections, this term has been included as required by the formatting requirements of word document submissions (i.e., docx submissions) pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A pet toy comprising:
a body extending between a first end and a second end along a center longitudinal axis;
a first enlarged member that defines the first end of the body;
a second enlarged member that defines the second end of the body, wherein the second enlarged member has an inner surface;
an elongated central portion of the body that extends between the first enlarged member and the second enlarged member, wherein the elongated central portion has an inner surface;
a cavity defined by the inner surface of the elongated central portion and the inner surface of the second enlarged member; and
a plurality of openings defined in the second enlarged member, wherein the plurality of openings are in open communication with the cavity, and the plurality of openings permit a treat stored in the cavity to exit the cavity in response to being ejected by a plunger that is inserted and moved axially through the cavity along the center longitudinal axis and the plunger having a diameter that complements an inner diameter of the elongated central portion, wherein the pet treat is a paste or paste-like material.

2. The pet toy of claim 1, wherein the plurality of openings includes a central opening that is coaxial along the center longitudinal axis.

3. The pet toy of claim 2, wherein the plurality of openings includes a first set of openings arranged as a first ring surrounding the central opening.

4. The pet toy of claim 3, wherein the plurality of openings includes a second set of openings arranged as a second ring concentrically surrounding the first set of openings.

5. The pet toy of claim 1, wherein at least one opening from the plurality of openings includes an outer portion thereof that defines a counterbore.

6. The pet toy of claim 5, wherein the plurality of openings includes a central opening includes a circular counterbore.

7. The pet toy of claim 5, wherein the at least one opening is positioned near a perimeter of the second enlarged member and has a trapezoidal counterbore.

8. The pet toy of claim 5, wherein the counterbore is configured to retain the pet treat therein such that the pet treat does not spill outward beyond the second end of pet toy.

9. The pet toy of claim 5, wherein there is a counterbore formed in each opening of the plurality of openings, wherein a collective volume the counterbores is less than a volume of the cavity.

10. The pet toy of claim 9, wherein the collective volume of the counterbores is at most about ⅓ of the volume of the cavity that is adapted to permit at least 3 incremental discharges of the pet treat from the cavity in response to actuation of the plunger without needing to refill the cavity with the pet treat between incremental discharges.

11. A method for dispensing a pet treat from a pet toy, the method comprising:
providing a pet toy comprising a body defining an internal cavity and a plurality of openings formed in the body;
loading the internal cavity with a quantity of a treat material sufficient for multiple dispensing operations, wherein the treat material is a paste or paste-like material;
actuating a plunger through the internal cavity to incrementally dispense a portion of the treat material through at least one of the openings;
allowing a pet to access and consume the dispensed portion of the treat material; and
repeating the actuation of the plunger to dispense successive portions of the treat material from the internal cavity without reloading the cavity between dispensing operations.

12. The method of claim 11, further comprising:
moving the plunger a first distance parallel to a longitudinal axis of the body, wherein the first distance is less than a total length of the internal cavity.

13. The method of claim 12, further comprising:
discharging a first portion of treat material in response moving the plunger the first distance; and
providing the pet toy to the pet after discharging the first portion, wherein the first portion of treat material is adapted to be consumed by the pet.

14. The method of claim 13, further comprising:
discharging a second portion of treat material in response to moving the plunger a second distance parallel to the longitudinal axis of the body, wherein the second distance is less than the total length of the internal cavity;
providing the pet toy to the pet after discharging the second portion, wherein the second portion of treat material is adapted to be consumed by the pet; and
wherein the pet toy is not reloaded with treat material between discharging the first portion and the second portion.

15. The method of claim 14, further comprising:
discharging a third portion of treat material in response to moving the plunger a third distance parallel to the longitudinal axis of the body, wherein the third distance is less than the total length of the internal cavity;
providing the pet toy to the pet after discharging the third portion, wherein the third portion of treat material is adapted to be consumed by the pet; and
wherein the pet toy is not reloaded with treat material between discharging the second portion and the third portion.

16. The method of claim 11, further comprising:
dispensing the treat material through at least one opening from the plurality of openings that are formed in an enlarged member at an end of the pet toy, wherein the enlarged member at least partially defines a barbell configuration of the pet toy.

17. The method of claim 11, further comprising:
dispensing the treat material into a counterbore of the at least one opening.

18. In combination, a pet toy, a pet treat, and a plunger, wherein the combination comprises:
a pet toy body defining a cavity and a plurality of openings in open communication with the cavity;
a plunger having a proximal end and a distal end, wherein the distal end of the plunger has an outer diameter that complements an inner diameter of the cavity, and the plunger has a length measured from the proximal end to the distal end, wherein the length of the plunger is less than a length of the cavity;
wherein the pet toy body receives a pet treat within the cavity, wherein the pet treat is a paste or paste-like material; and
wherein the distal end of the plunger moves incrementally through the cavity to incrementally dispense the pet treat outward from the cavity through the plurality of openings.

19. The combination of claim 18, wherein at least one opening from the plurality of openings has a counterbore, and wherein the distal end of the plunger moves incrementally through the cavity to incrementally dispense the pet treat outward from the cavity to dispose the pet treat in the counterbore.

20. The combination of claim 18, further comprising:
a first enlarged member that defines a first end of the pet toy body;
a second enlarged member that defines a second end of the pet toy body;
wherein the first enlarged member has a diameter that is greater than the second enlarged member to cause the pet toy to roll along a curved trajectory as the pet toy rotates about the longitudinal axis; and
wherein the plurality of openings, through which the pet treat is expelled in response to axial movement of the plunger through the cavity, are defined in the second enlarged member that defines the second end of the pet toy body.
